(19) United States
(12) Patent Application Publication
(10) Pub. No.: US 2008/0170239 A1
(43) Pub. Date: Jul. 17, 2008

(54) Light Source Unit For Alignment, Alignment Apparatus, Exposure Apparatus, Digital Exposure Apparatus, Alignment Method, Exposure Method And Method For Setting Lighting Apparatus Condition

(75) Inventors: Hiroshi Uemura, Kanagawa-ken (JP); Toru Katayama, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku (JP)

(21) Appl. No.: 11/886,123

(22) PCT Filed: Feb. 28, 2006
(86) PCT No.: PCT/JP2006/303795

§ 371 Date: Sep. 11, 2007

(30) Foreign Application Priority Data
Mar. 11, 2005 (JP) 2005-070105

(51) Int. Cl. G01B 11/14

(52) U.S. Cl. 356/620

(57) ABSTRACT

A light source unit (100A) for alignment is provided with a camera (30), a lighting apparatus (102), and furthermore, a changing section (110), an image processing section (112), an extracting section (114) and a setting section (116). The changing section (110) controls drive of a shifting mechanism (118) based on information from the setting section (116), and the lighting apparatus (102) is shifted to a desired position. The image processing section (112) acquires a quantitative data relating to an alignment mark (50) and contrast of its peripheral part (104), based on image pickup information from the camera (30). The extracting section (114) extracts an interval wherein the contrast is optimized as an optimum interval, based on the quantitative data. The setting section (116) gives information to the changing section (110) so that the interval between the lighting apparatus (102) and the alignment mark (50) is the optimum interval.

### TECHNICAL FIELD

The present invention relates to a light source unit for alignment, an alignment apparatus, an alignment method, and a method for setting a lighting apparatus condition, used in a case where a standard pattern formed on a workpiece is irradiated with light from a lighting apparatus, a camera is used for taking an image of the standard pattern and a surrounding area thereof to detect the workpiece, and the position of the workpiece is aligned based on a detection result. The present invention also relates to an exposure apparatus, a digital exposure apparatus, and an exposure method utilizing the light source unit for alignment, the alignment apparatus, the alignment method, and the method for setting a lighting apparatus condition.

### BACKGROUND ART

In recent years, in conventional exposure apparatuses, technologies for alignment measurement processes, which include detecting an alignment mark on a substrate with an optical reading means such as a CCD camera prior to exposure, have been widely used.

To carry out such an alignment measurement with high accuracy using the optical image pick-up means, it is important to obtain a high-contrast image, i.e., an image having a large tone difference between the position detection object mark and the surrounding area thereof.

In view of obtaining the high-contrast image, it is important to take an image of the alignment mark under lighting conditions suitable for the type of mark and the surface state of the substrate.

However, in conventional exposure devices, the lighting conditions (lighting angle, working distance, lighting color, lighting time, lighting intensity) are constant, and a cumbersome process, such as replacement of an entire lighting apparatus, is required for changing lighting conditions.

Several methods for optimizing image contrast have conventionally been proposed.

For example, in Patent Document 1, in a component mounting apparatus, a plurality of groups of light sources are formed around an optical axis of a camera serving as a lighting means for positioning, wherein the groups have different distances from the optical axis and are controlled separately to optimize image contrast.

In Patent Document 2, in a recognition testing apparatus with a camera, image contrast is calculated while gradually changing the luminosity of illumination light, wherein the luminosity is controlled such that image contrast is maximized.

In Patent Document 3, in an IC bonding wire testing apparatus, LED arrays are formed concentrically to emit light toward an object at different angles, wherein channels of the LED arrays are controlled and used for lighting depending on the object.

In Patent Document 4, in an optical measuring apparatus such as an optical microscope, or an image measuring apparatus, light emitting devices having different lighting colors are arranged in an annular shape perpendicularly to the optical axis of an optical reading system. Emission of light from the light emitting devices is appropriately controlled to select the lighting color depending on the surface color of the measurement object, whereby image contrast is increased to improve detection accuracy.

In Patent Document 5, in a printing apparatus for printing predetermined information on a printed board with a printing head, and taking an image of such information with a camera, lighting color of a lighting means for irradiating the printed board with light is set based on at least one of the color of the information that is printed on the board, e.g., an alignment mark, and the color of a solder resist on the board.

Other mechanisms for controlling lighting conditions include those of Patent Documents 6 to 8.

Patent Document 1: Japanese Laid-Open Patent Publication No. 9-116297

Patent Document 2: Japanese Laid-Open Patent Publication No. 10-62134

Patent Document 3: Japanese Laid-Open Patent Publication No. 4-241476

Patent Document 4: Japanese Laid-Open Patent Publication No. 2003-337365

Patent Document 5: Japanese Laid-Open Patent Publication No. 2004-273774

Patent Document 6: Japanese Laid-Open Patent Publication No. 6-109443

Patent Document 7: Japanese Laid-Open Patent Publication No. 11-220177

Patent Document 8: Japanese Laid-Open Patent Publication No. 7-151919

### DISCLOSURE OF THE INVENTION

For example, when using an exposure apparatus for a printed board, an image of an alignment mark formed on the board is taken with a CCD camera in order to measure the position and deformation of the board. In general, the shape and form of the alignment mark change depending on users, as well as on applications and processes of the exposure apparatus. For example, the alignment mark comprises a through hole, a through bore, an etching mark, a laser mark, a via hole, or the like.

Further, the surface state of the board, such as the flatness of a copper foil, the luster of a copper foil surface, or the color or reflection of a photosensitive material, generally depends on the substrates and processes.

Conventional alignment measurement devices have a disadvantage in that they cannot be used when the shape and form of the alignment mark, and the surface state of the board, are changed in various ways.

In view of these problems, an object of the present invention is to provide a light source unit for alignment, an alignment apparatus, an alignment method, and a method for setting lighting apparatus conditions, which are capable of obtaining a high-contrast image in order to carry out various subsequent processes, such as an exposure treatment, with excellent accuracy even when the types of workpieces and the alignment mark are changed in various ways.

Another object of the present invention is to provide an exposure apparatus, a digital exposure apparatus, and an exposure method, which are capable of obtaining a high-contrast image in order to carry out subsequent exposure treatments with excellent accuracy, even when the type of workpiece, the shape and form of the alignment mark, and the surface state of the substrate are changed in various ways.

It should be noted that the term “type of workpiece” refers to the surface state, color, shape, etc., of the workpiece, whereas the term “type of standard pattern” refers to the shape, form, etc., of the mark or pattern.

A first light source unit for alignment according to the present invention is used for an alignment means for detecting a standard pattern formed on a workpiece in order to align the position of the workpiece, and comprises a camera for taking an image of the standard pattern and a surrounding area thereof, and a ring-shaped lighting apparatus for emitting light to the standard pattern. The first light source unit further comprises a changing means for moving the lighting apparatus relatively closer to or farther away from the standard pattern so as to change the distance between the lighting apparatus and the standard pattern, an image processing means for obtaining quantitative data on contrast between the standard pattern and the surrounding area based on image information from the camera, an extraction means for selecting an optimum distance between the lighting apparatus and the standard pattern, by which contrast is optimized, based on the quantitative data from a plurality of distances obtained during relative displacement of the lighting apparatus by the changing means, and a setting means for setting the distance between the lighting apparatus and the standard pattern to the optimum distance during an alignment process using the alignment means. For example, the standard pattern may be a mark or a pattern used as an alignment mark.

The first light source unit may comprise a memory, having a table in which the optimum distance corresponding to at least the type of workpiece is recorded, an entry means for recording the optimum distance corresponding to at least the type of workpiece in the table, and a readout means for retrieving from the table the optimum distance, corresponding to at least the type of workpiece, of an alignment object during an alignment process using the alignment means. Thus, the distance between the lighting apparatus and the standard pattern can be set to the optimum distance by the setting means, during an alignment process using the alignment means.

A second light source unit for alignment according to the present invention is used for an alignment means for detecting a standard pattern formed on a workpiece in order to align the position of the workpiece, and comprises a camera for taking an image of the standard pattern and a surrounding area thereof, and a ring-shaped lighting apparatus for emitting light to the standard pattern. The second light source unit comprises a changing means for changing at least the lighting angle of the light emitted from the lighting apparatus to the standard pattern, an image processing means for obtaining quantitative data on contrast between the standard pattern and the surrounding area based on image information from the camera, an extraction means for selecting an optimum lighting angle, under which contrast is optimized, based on the quantitative data from a plurality of lighting angles changeable by the changing means, and a setting means for setting the lighting angle of the lighting apparatus to the optimum lighting angle during an alignment process using the alignment means.

In the second light source unit, the lighting apparatus comprises a hollow, dome-shaped casing, and when a line of light sources on an inner circumference around the center axis of the casing is defined as a row, light sources of the 1st, 2nd, . . . , and nth rows are formed along an inner wall of the casing, in this order, from the bottom of the casing.

The second light source unit may be configured such that a row of light sources is selected from among the 1st, 2nd, . . . , and nth rows in order to change the lighting angle of the lighting apparatus and/or the distance between the driven light sources and the workpiece by the changing means, an optimum lighting angle and/or an optimum distance, under which contrast is optimized, are selected by the extraction means from among a plurality of lighting angles and/or a plurality of distances which are changeable by the changing means, and the lighting angle and/or the distance of the lighting apparatus are set to the optimum lighting angle and/or the optimum distance by the setting means during an alignment process using the alignment means.

The second light source unit may comprise a memory, having a table in which the optimum lighting angle and/or the optimum distance corresponding to at least the type of workpiece are recorded, an entry means for recording the optimum lighting angle and/or the optimum distance corresponding to at least the type of workpiece in the table, and a readout means for retrieving from the table the optimum lighting angle and/or the optimum distance, corresponding to at least the type of workpiece, of an alignment object during an alignment process using the alignment means. Thus, the lighting angle and/or the distance of the lighting apparatus may be set to the optimum lighting angle and/or the optimum distance by the setting means during an alignment process using the alignment means.

The second light source unit may be configured such that the light sources of each row within the lighting apparatus have different lighting colors, a row of light sources is selected from among the 1st, 2nd, . . . , and nth rows in order to change the lighting angle and/or the distance, wherein part or all of the light sources of the selected row are selected and driven by the changing means in order to change the lighting color, an optimum lighting angle and/or an optimum distance, as well as an optimum lighting color, under which contrast is optimized, are selected by the extraction means from among a plurality of lighting angles and/or a plurality of distances, as well as a plurality of lighting colors, which are changeable by the changing means, and the lighting angle and/or the distance, as well as the lighting color of the lighting apparatus, are set to the optimum lighting angle and/or the optimum distance, as well as the optimum lighting color, by the setting means during an alignment process using the alignment means.

The second light source unit may be such that the light sources of each row within the lighting apparatus have the same lighting color, and each of adjacent rows have different lighting colors, a row of light sources is selected from among the 1st, 2nd, . . . , and nth rows in order to change the lighting angle and/or the distance, as well as the lighting color, by the changing means, an optimum lighting angle and/or an optimum distance, as well as an optimum lighting color, under which contrast is optimized, are selected by the extraction means from a plurality of lighting angles and/or a plurality of distances, as well as a plurality of lighting colors, which are changeable by the changing means, and the lighting angle and/or the distance, as well as the lighting color of the lighting apparatus, are set to the optimum lighting angle and/or the optimum distance, as well as the optimum lighting color, by the setting means during an alignment process using the alignment means.

The second light source unit may comprise a memory, having a table in which the optimum lighting angle and/or the optimum distance, as well as the optimum lighting color, corresponding to at least the type of workpiece are recorded, an entry means for recording the optimum lighting angle and/or the optimum distance, as well as the optimum lighting color, corresponding to at least the type of workpiece in the table, and a readout means for retrieving from the table the optimum lighting angle and/or the optimum distance, as well as the optimum lighting color, corresponding to at least the type of workpiece, of an alignment object during an alignment process using the alignment means. Thus, the lighting angle and/or the distance, as well as the lighting color of the lighting apparatus, may be set to the optimum lighting angle and/or the optimum distance, as well as the optimum lighting color, by the setting means during an alignment process using the alignment means.

A third light source unit for alignment according to the present invention is used for an alignment means for detecting a standard pattern formed on a workpiece in order to align the position of the workpiece, and comprises a camera for taking an image of the standard pattern and a surrounding area thereof, and a ring-shaped lighting apparatus for emitting light to the standard pattern. The third light source unit comprises a changing means for changing at least the lighting color of the light emitted from the lighting apparatus to the standard pattern, an image processing means for obtaining quantitative data on contrast between the standard pattern and the surrounding area based on image information from the camera, an extraction means for selecting an optimum lighting color, under which contrast is optimized, based on the quantitative data from a plurality of lighting colors changeable by the changing means, and a setting means for setting the lighting color of the lighting apparatus to the optimum lighting color during an alignment process using the alignment means.

In the third light source unit, the lighting apparatus comprises a hollow, dome-shaped casing, and when a line of light sources on an inner circumference around the center axis of the casing is defined as a row, light sources of the 1st, 2nd, . . . , and nth rows are formed along an inner wall of the casing, in this order, from the bottom of the casing. The light sources of each row have the same lighting color, and each of adjacent rows have different lighting colors, and the light sources of all or part of the 1st, 2nd, . . . , and nth rows are selected by the changing means and driven in order to change the lighting color.

The third light source unit may comprise a memory, having a table in which the optimum lighting color corresponding to at least the type of workpiece is recorded, an entry means for recording the optimum lighting color corresponding to at least the type of workpiece in the table, and a readout means for retrieving from the table the optimum lighting color, corresponding to at least the type of workpiece, of an alignment object during an alignment process using the alignment means. Thus, the lighting color of the lighting apparatus may be set to the optimum lighting color by the setting means during an alignment process using the alignment means.

In the first to third light source units, the image processing means may be configured such that a tone difference between the standard pattern and the surrounding area is obtained as quantitative data, wherein contrast is optimized when the tone difference is maximized.

Alternatively, the image processing means may be configured such that a histogram, showing the change of pixel number depending on tone, is obtained based on the image information, a peak having the maximum tone value and a peak having the minimum tone value are extracted from a plurality of peaks within the histogram, the ratio of the maximum tone value to the minimum tone value is obtained as the quantitative data, and the contrast is optimized when the ratio is maximized.

A fourth light source unit for alignment according to the present invention is used for an alignment means for detecting a standard pattern formed on a workpiece in order to align the position of the workpiece, and comprises a camera for taking an image of the standard pattern and a surrounding area thereof, and a strobe lighting apparatus for emitting light toward the standard pattern. The fourth light source unit comprises a memory having a table in which a parameter is recorded, including at least the strobe lighting time and strobe lighting quantity of the strobe lighting apparatus corresponding to at least the type of workpiece and the standard pattern, a parameter readout means for retrieving from the table the parameter corresponding to the type of workpiece and the type of standard pattern, and a control means for controlling driving of the strobe lighting apparatus based on the parameter during an alignment process using the alignment means.

A fifth light source unit for alignment according to the present invention is used for an alignment means for detecting a standard pattern formed on a workpiece in order to align the position of the workpiece, and comprises a camera for taking an image of the standard pattern and a surrounding area thereof, and a strobe lighting apparatus for emitting light toward the standard pattern. The fifth light source unit further comprises a plurality of strobe light sources, having different light wavelengths in the strobe lighting apparatus, a memory having a table in which a parameter is recorded, including at least the light wavelength corresponding to at least the type of workpiece and the standard pattern, a parameter readout means for retrieving from the table the parameter corresponding to the type of workpiece and the type of standard pattern, and a control means for selecting and driving a strobe light source corresponding to the light wavelength of the parameter during an alignment process using the alignment means.

A sixth light source unit for alignment according to the present invention is used for an alignment means for detecting a standard pattern formed on a workpiece in order to align the position of the workpiece, and comprises a camera for taking an image of the standard pattern and a surrounding area thereof, and a lighting apparatus for emitting light toward the standard pattern. The sixth light source unit further comprises a plurality of light sources, having different sizes, in the lighting apparatus, a memory having a table in which a parameter is recorded, including at least information on an optimum light source corresponding to the type of workpiece and the type of standard pattern, a parameter readout means for retrieving the parameter from the table, including information on the optimum light source, corresponding to the type of workpiece and the type of standard pattern, and a control means for selecting a light source corresponding to the information on the optimum light source of the read-out parameter from the light sources having different sizes during an alignment process using the alignment means.

In the sixth light source unit, the light sources having different sizes may include a ring-shaped light source, an epi-illumination light source, and a transmitted illumination light source.

A seventh light source unit for alignment according to the present invention is used for an alignment means for detecting a standard pattern formed on a workpiece in order to align the position of the workpiece, and comprises a camera for taking an image of the standard pattern and a surrounding area thereof, and a lighting apparatus for emitting light to the standard pattern. The seventh light source unit further comprises a memory having a table in which a parameter is recorded, including at least information on an optimum image processing condition corresponding to the type of workpiece and the type of standard pattern, and a parameter readout means for retrieving the parameter from the table, including information on the optimum image processing condition, corresponding to the type of workpiece and the type of standard pattern. Image data taken by the camera is subjected to image processing, corresponding to the information on the optimum image processing condition of the read-out parameter, during an alignment process using the alignment means.

The seventh light source unit may be configured such that the image processing includes a process for obtaining a tone difference between the standard pattern and the surrounding area, and a process of extracting a peak having a maximum tone value and a peak having a minimum tone value, from among a plurality of peaks in a histogram showing the change of pixel number depending on tone, in order to obtain a ratio of the maximum tone value to the minimum tone value.

Two or more of the fourth to seventh light source units according to the present invention may be used in combination.

In the fourth to seventh light source units according to the present invention, parameters may be set by the user.

The first to seventh light source units according to the present invention are capable of obtaining a high-contrast image, so as to carry out various subsequent processes such as an exposure treatment with excellent accuracy, even when the type of workpiece and the standard pattern such as the alignment mark are changed in various ways.

An alignment apparatus according to the present invention comprises an alignment means for detecting a standard pattern formed on a workpiece in order to align the position of the workpiece, together with one of the above-described first to seventh light source units according to the present invention.

The alignment apparatus is capable of obtaining a high-contrast image so as to carry out various subsequent processes such as an exposure treatment with excellent accuracy, even when the type of workpiece and the standard pattern such as the alignment mark are changed in various ways.

An exposure apparatus according to the present invention comprises an alignment apparatus having an alignment means for detecting a standard pattern formed on a workpiece in order to align the position of the workpiece, an image being optically formed on the aligned workpiece in an exposure treatment by the exposure apparatus, wherein the alignment apparatus comprises one of the first to seventh light source units according to the present invention.

A digital exposure apparatus according to the present invention comprises an alignment apparatus having an alignment means for detecting a standard pattern formed on a workpiece in order to align the position of the workpiece, and a plurality of exposure heads for optically forming an image on the aligned workpiece during an exposure treatment, wherein the alignment apparatus comprises one of the first to seventh light source units according to the present invention.

The exposure apparatus and the digital exposure apparatus according to the present invention are capable of obtaining a high-contrast image so as to carry out a subsequent exposure treatment with excellent accuracy, even when the type of workpiece, the shape and form of the standard pattern such as the alignment mark, and the surface state of a substrate are changed in various ways.

A first alignment method according to the present invention is conducted such that a standard pattern formed on a workpiece is irradiated with light from a ring-shaped lighting apparatus, a camera is used for taking an image of the standard pattern and a surrounding area thereof in order to detect the workpiece, and the position of the workpiece is aligned based on a detection result. The first alignment method comprises a moving step for moving the lighting apparatus relatively closer to or farther away from the standard pattern, an image processing step for obtaining quantitative data on contrast between the standard pattern and the surrounding area based on image information from the camera, an extracting step for selecting an optimum distance between the lighting apparatus and the standard pattern, under which contrast is optimized, based on the quantitative data from a plurality of distances obtained upon relative displacement of the lighting apparatus during the moving step, and a setting step for setting the distance between the lighting apparatus and the standard pattern to the optimum distance during the alignment process.

The first alignment method may further comprise an entry step for recording the optimum distance corresponding to at least the type of workpiece in a table, and a readout step for retrieving from the table the optimum distance, corresponding to at least the type of workpiece, of an alignment object during the alignment process. Thus, the distance between the lighting apparatus and the standard pattern is set to the optimum distance by the setting step during the alignment process.

A second alignment method according to the present invention is conducted such that a standard pattern formed on a workpiece is irradiated with light from a ring-shaped lighting apparatus, a camera is used for taking an image of the standard pattern and a surrounding area thereof in order to detect the workpiece, and the position of the workpiece is aligned based on a detection result. The second alignment method comprises a changing step for changing at least a lighting angle of the light emitted from the lighting apparatus to the standard pattern, an image processing step for obtaining quantitative data on contrast between the standard pattern and the surrounding area based on image information from the camera, an extracting step for selecting an optimum lighting angle, under which contrast is optimized, based on the quantitative data from a plurality of lighting angles obtained during the changing step, and a setting step for setting the lighting angle of the lighting apparatus to the optimum lighting angle during the alignment process.

The second alignment method may further be conducted such that the lighting apparatus comprises a hollow, dome-shaped casing, and when a line of light sources on an inner circumference around the center axis of the casing is defined as a row, light sources of the 1st, 2nd, . . . , and nth rows are formed along an inner wall of the casing, in this order, from the bottom of the casing.

The second alignment method may be conducted such that a row of light sources is selected by the changing step from among the 1st, 2nd, . . . , and nth rows in order to change the lighting angle of the lighting apparatus and/or the distance between the driven light sources and the workpiece, an optimum lighting angle and/or an optimum distance, under which contrast is optimized, are selected by the extracting step from among a plurality of lighting angles and/or a plurality of distances which are obtained during the changing step, and the lighting angle and/or the distance of the lighting apparatus are set by the setting step to the optimum lighting angle and/or the optimum distance during the alignment process.

The second alignment method may comprise an entry step for recording the optimum lighting angle and/or the optimum distance, corresponding to at least the type of workpiece, in a table, and a readout step for retrieving from the table the optimum lighting angle and/or the optimum distance, corresponding to at least the type of workpiece, of an alignment object during the alignment process. Thus, the lighting angle and/or the distance of the lighting apparatus are set by the setting step to the optimum lighting angle and/or the optimum distance during the alignment process.

The second alignment method may be conducted such that the light sources of each row within the lighting apparatus have different lighting colors, a row of light sources is selected from among the 1st, 2nd, . . . , and nth rows in order to change the lighting angle and/or the distance, wherein part or all of the light sources of the selected row are selected and driven during the changing step in order to change the lighting color, an optimum lighting angle and/or an optimum distance, as well as an optimum lighting color, under which contrast is optimized, are selected by the extracting step from among a plurality of lighting angles and/or a plurality of distances, as well as a plurality of lighting colors, which are obtained during the changing step, and the lighting angle and/or the distance, as well as the lighting color of the lighting apparatus, are set by the setting step to the optimum lighting angle and/or the optimum distance, as well as the optimum lighting color, during the alignment process.

The second alignment method may be conducted such that the light sources of each row in the lighting apparatus have the same lighting color, and each of adjacent rows have different lighting colors, a row of light sources is selected by the changing step from among the 1st, 2nd, . . . , and nth rows in order to change the lighting angle and/or the distance, as well as the lighting color, an optimum lighting angle and/or an optimum distance, as well as an optimum lighting color, under which contrast is optimized, are selected by the extracting step from among a plurality of lighting angles and/or a plurality of distances, as well as a plurality of lighting colors, which are obtained during the changing step, and the lighting angle and/or the distance, as well as the lighting color, of the lighting apparatus are set by the setting step to the optimum lighting angle and/or the optimum distance, as well as the optimum lighting color, during the alignment process.

The second alignment method may comprise an entry step for recording the optimum lighting angle and/or the optimum distance, as well as the optimum lighting color, corresponding to at least the type of workpiece, in a table, and a readout step for retrieving from the table the optimum lighting angle and/or the optimum distance, as well as the optimum lighting color, corresponding to at least the type of workpiece, of an alignment object during the alignment process. Thus, the lighting angle and/or the distance, as well as the lighting color, of the lighting apparatus are set by the setting step to the optimum lighting angle and/or the optimum distance, as well as the optimum lighting color, during the alignment process.

A third alignment method according to the present invention is conducted such that a standard pattern formed on a workpiece is irradiated with light from a ring-shaped lighting apparatus, a camera is used for taking an image of the standard pattern and a surrounding area thereof in order to detect the workpiece, and the position of the workpiece is aligned based on a detection result. The third alignment method comprises a changing step for changing at least the lighting color of light emitted from the lighting apparatus to the standard pattern, an image processing step for obtaining quantitative data on contrast between the standard pattern and the surrounding area based on image information from the camera, an extracting step for selecting an optimum lighting color, under which contrast is optimized, based on the quantitative data from a plurality of lighting colors obtained during the changing step, and a setting step for setting the lighting color of the lighting apparatus to the optimum lighting color during the alignment process.

The third alignment method may be conducted such that the lighting apparatus comprises a hollow, dome-shaped casing, and when a line of light sources on an inner circumference around the center axis of the casing is defined as a row, light sources of the 1st, 2nd, . . . , and nth rows are formed along an inner wall of the casing, in this order, from the bottom of the casing. The light sources of each row have the same lighting color, and each of adjacent rows have different lighting colors, wherein the light sources of all or part of the 1st, 2nd, . . . , and nth rows are selected and driven by the changing step in order to change the lighting color.

The third alignment method may comprise an entry step for recording the optimum lighting color corresponding to at least the type of workpiece in a table, and a readout step for retrieving from the table the optimum lighting color, corresponding to at least the type of workpiece, of an alignment object during the alignment process. Thus, the lighting color of the lighting apparatus is set to the optimum lighting color by the setting step during the alignment process.

In the first to third alignment methods according to the present invention, the image processing step may be conducted such that a tone difference between the standard pattern and the surrounding area is obtained as the quantitative data, and contrast is optimized when the tone difference is maximized.

Alternatively, the image processing step may be conducted such that a histogram, showing the change of pixel number depending on tone, is obtained based on the image information, a peak having the maximum tone value and a peak having the minimum tone value are extracted from a plurality of peaks within the histogram, the ratio of the maximum tone value to the minimum tone value is obtained as the quantitative data, and contrast is optimized when the ratio is maximized.

A fourth alignment method according to the present invention is conducted such that a standard pattern formed on a workpiece is irradiated with light from a strobe lighting apparatus, a camera is used for taking an image of the standard pattern and a surrounding area thereof in order to detect the workpiece, and the position of the workpiece is aligned based on a detection result. A table, in which a parameter is recorded is used in the fourth alignment method, including at least the strobe lighting time and strobe lighting quantity of the strobe lighting apparatus, corresponding to at least the type of workpiece and the standard pattern. The fourth alignment method comprises a parameter readout step for retrieving from the table the parameter corresponding to the type of workpiece and the type of standard pattern, and a control step for controlling driving of the strobe lighting apparatus based on the parameter during the alignment process.

A fifth alignment method according to the present invention is conducted such that a standard pattern formed on a workpiece is irradiated with light from a strobe lighting apparatus, a camera is used for taking an image of the standard pattern and a surrounding area thereof in order to detect the workpiece, and the position of the workpiece is aligned based on a detection result. The strobe lighting apparatus comprises a plurality of strobe light sources, having different light wavelengths, wherein a table is used in the fifth alignment method, in which a parameter is recorded, including at least the light wavelength corresponding to at least the type of workpiece and the standard pattern. The fifth alignment method comprises a parameter readout step for retrieving from the table the parameter corresponding to the type of workpiece and the type of standard pattern, and a control step for selecting and driving a strobe light source, corresponding to the light wavelength of the parameter, during the alignment process.

A sixth alignment method according to the present invention is conducted such that a standard pattern formed on a workpiece is irradiated with light from a lighting apparatus, a camera is used for taking an image of the standard pattern and a surrounding area thereof in order to detect the workpiece, and the position of the workpiece is aligned based on a detection result. The lighting apparatus comprises a plurality of light sources, having different sizes, wherein a table is used in the sixth alignment method, in which a parameter is recorded, including at least information on an optimum light source corresponding to the type of workpiece and the type of standard pattern. The sixth alignment method comprises a parameter readout step for retrieving from the table the parameter, including information on the optimum light source corresponding to the type of workpiece and the type of standard pattern, and a control step for selecting a light source, corresponding to the information on the optimum light source of the read-out parameter from the light sources having different sizes, during the alignment process.

In the sixth alignment method, the light sources having different sizes may include a ring-shaped light source, an epi-illumination light source, and a transmitted illumination light source.

A seventh alignment method according to the present invention is conducted such that a standard pattern formed on a workpiece is irradiated with light from a lighting apparatus, a camera is used for taking an image of the standard pattern and a surrounding area thereof in order to detect the workpiece, and the position of the workpiece is aligned based on a detection result. A table is used in the seventh alignment method, in which a parameter is recorded, including at least information on an optimum image processing condition corresponding to the type of workpiece and the type of standard pattern. The seventh alignment method comprises a parameter readout step for retrieving from the table the parameter, including information on the optimum image processing condition, corresponding to the type of workpiece and the type of standard pattern, and an image processing step for subjecting image data taken by the camera to image processing, corresponding to the information on the optimum image processing condition of the read-out parameter, during the alignment process.

In the seventh alignment method, the image processing includes a process for obtaining a tone difference between the standard pattern and the surrounding area, and a process for extracting a peak having a maximum tone value and a peak having a minimum tone value, from among a plurality of peaks in a histogram showing the change of pixel number depending on tone, in order to obtain a ratio of the maximum tone value to the minimum tone value.

Two or more of the fourth to seventh alignment methods according to the present invention may be used in combination.

In the fourth to seventh alignment methods according to the present invention, parameters may be set by the user.

The first to seventh alignment methods according to the present invention are capable of obtaining a high-contrast image, so as to carry out various subsequent processes such as an exposure treatment with excellent accuracy, even when the type of workpiece and the standard pattern such as the alignment mark are changed in various ways.

An exposure method according to the present invention comprises the steps of irradiating a standard pattern formed on a workpiece with light from a lighting apparatus, taking an image of the standard pattern and a surrounding area thereof with a camera in order to detect the workpiece, aligning a position of the workpiece based on a detection result, and optically forming an image on the aligned workpiece during an exposure treatment. The workpiece is aligned by one of the first to seventh alignment methods according to the present invention, wherein the image is optically formed on the aligned workpiece during the exposure treatment.

The exposure method is capable of obtaining a high-contrast image so as to carry out a subsequent exposure treatment with excellent accuracy, even when the type of workpiece, the shape and form of the standard pattern such as the alignment mark, and the surface state of a substrate are changed in various ways.

A first method for setting a lighting apparatus condition according to the present invention is used in an alignment process containing the steps of irradiating a standard pattern formed on a workpiece with light from a ring-shaped lighting apparatus, taking an image of the standard pattern and a surrounding area thereof with a camera in order to detect the workpiece, and aligning the position of the workpiece based on a detection result. The first method comprises a moving step for moving the lighting apparatus relatively closer to or farther away from the standard pattern, an image processing step for obtaining quantitative data on contrast between the standard pattern and the surrounding area, based on image information from the camera, and an extracting step for selecting an optimum distance between the lighting apparatus and the standard pattern, under which contrast is optimized, based on quantitative data from a plurality of distances obtained upon relative displacement of the lighting apparatus during the moving step. The distance between the lighting apparatus and the standard pattern is set to the optimum distance in the alignment process.

The first method includes an entry step for recording the optimum distance, corresponding to at least the type of workpiece on a table, and a readout step for retrieving from the table the optimum distance, corresponding to at least the type of workpiece of an alignment object, during the alignment process. Thus, the distance between the lighting apparatus and the standard pattern is set to the optimum distance during the alignment process.

A first method for setting a lighting apparatus condition according to the present invention is used in an alignment process containing the steps of irradiating a standard pattern formed on a workpiece with light from a ring-shaped lighting apparatus, taking an image of the standard pattern and a surrounding area thereof with a camera in order to detect the workpiece, and aligning the position of the workpiece based on a detection result. The method comprises a changing step for changing at least the lighting angle of the light emitted from the lighting apparatus toward the standard pattern, an image processing step for obtaining quantitative data on contrast between the standard pattern and the surrounding area based on image information from the camera, and an extracting step for selecting an optimum lighting angle, under which contrast is optimized, based on the quantitative data from a plurality of lighting angles obtained during the changing step. The lighting angle of the lighting apparatus is set to the optimum lighting angle during the alignment process.

In this method, the lighting apparatus may comprise a hollow, dome-shaped casing. When a line of light sources on an inner circumference around the center axis of the casing is defined as a row, light sources of the 1st, 2nd, . . . , and nth rows may be formed on an inner wall of the casing, in this order, from the bottom of the casing.

The method may be conducted such that a row of light sources is selected by the changing step, from among the 1st, 2nd, . . . , and nth rows, in order to change the lighting angle of the lighting apparatus and/or the distance between the driven light sources and the workpiece, an optimum lighting angle and/or an optimum distance, under which contrast is optimized, are selected by the extracting step from among a plurality of lighting angles and/or a plurality of distances obtained during the changing step, and wherein the lighting angle and/or the distance of the lighting apparatus are set to the optimum lighting angle and/or the optimum distance during the alignment process.

The method may comprise an entry step for recording the optimum lighting angle and/or the optimum distance corresponding to at least the type of workpiece in a table, and a readout step for retrieving from the table the optimum lighting angle and/or the optimum distance, corresponding to at least the type of workpiece, of an alignment object during the alignment process. Thus, the lighting angle and/or the distance of the lighting apparatus may be set to the optimum lighting angle and/or the optimum distance during the alignment process.

The method may be conducted such that the light sources of each row within the lighting apparatus have different lighting colors, a row of light sources is selected from among the 1st, 2nd, . . . , and nth rows so as to change the lighting angle and/or the distance, and part or all of the light sources of the selected row is selected and driven by the changing step in order to change the lighting color, an optimum lighting angle and/or an optimum distance, as well as an optimum lighting color, under which contrast is optimized, are selected by the extracting step from among a plurality of lighting angles and/or a plurality of distances, as well as a plurality of lighting colors, obtained during the changing step, and the lighting angle and/or the distance, as well as the lighting color, of the lighting apparatus are set to the optimum lighting angle and/or the optimum distance, as well as the optimum lighting color, during the alignment process.

The method may be conducted such that the light sources of each row within the lighting apparatus have the same lighting color, and each of the adjacent rows have different lighting colors, a row of light sources is selected by the changing step from among the 1st, 2nd, . . . , and nth rows in order to change the lighting angle and/or the distance, as well as the lighting color, an optimum lighting angle and/or an optimum distance, as well as an optimum lighting color, under which contrast is optimized, are selected by the extracting step from among a plurality of lighting angles and/or a plurality of distances, as well as a plurality of lighting colors, obtained in the changing step, and the lighting angle and/or the distance, as well as the lighting color, of the lighting apparatus are set to the optimum lighting angle and/or the optimum distance, as well as the optimum lighting color, during the alignment process.

The method may comprise an entry step for recording in a table the optimum lighting angle and/or the optimum distance, as well as the optimum lighting color, corresponding to at least the type of workpiece, and a readout step for retrieving from the table the optimum lighting angle and/or the optimum distance, as well as the optimum lighting color, corresponding to at least the type of workpiece, of an alignment object in the alignment process. Thus, the lighting angle and/or the distance, as well as the lighting color, of the lighting apparatus may be set to the optimum lighting angle and/or the optimum distance, as well as the optimum lighting color, during the alignment process.

A third method for setting a lighting apparatus condition according to the present invention is used in an alignment process containing the steps of irradiating a standard pattern formed on a workpiece with light from a ring-shaped lighting apparatus, taking an image of the standard pattern and a surrounding area thereof with a camera in order to detect the workpiece, and aligning the position of the workpiece based on a detection result. The third method comprises a changing step for changing at least the lighting color of the light emitted from the lighting apparatus toward the standard pattern, an image processing step for obtaining quantitative data on contrast between the standard pattern and the surrounding area based on image information from the camera, and an extracting step for selecting an optimum lighting color, under which contrast is optimized, based on the quantitative data from a plurality of lighting colors obtained during the changing step. The lighting color of the lighting apparatus is set to the optimum lighting color during the alignment process.

The method may be conducted wherein the lighting apparatus comprises a hollow, dome-shaped casing, and when a line of light sources on an inner circumference around the center axis of the casing is defined as a row, light sources of the 1st, 2nd, . . . , and nth rows are formed along an inner wall of the casing, in this order, from the bottom of the casing. The light sources of each row have the same lighting color, and each of the adjacent rows have different lighting colors, wherein the light sources of all or part of the 1st, 2nd, . . . , and nth rows are selected by the changing step and driven in order to change the lighting color.

The method may further comprise an entry step for recording in a table the optimum lighting color corresponding to at least the type of workpiece, and a readout step for retrieving from the table the optimum lighting color, corresponding to at least the type of workpiece, of an alignment object during the alignment process. Thus, the lighting color of the lighting apparatus may be set to the optimum lighting color during the alignment process.

In the first to third methods for setting a lighting apparatus condition according to the present invention, the image processing step may be conducted such that a tone difference between the standard pattern and the surrounding area is obtained as quantitative data, wherein contrast is optimized when the tone difference is maximized.

Alternatively, the image processing step may be conducted such that a histogram, showing the change of pixel number depending on tone, is obtained based on the image information, a peak having the maximum tone value and a peak having the minimum tone value are extracted from a plurality of peaks in the histogram, the ratio of the maximum tone value to the minimum tone value is obtained as the quantitative data, and contrast is optimized when the ratio is maximized.

As described above, the light source unit for alignment, the alignment apparatus, the alignment method, and the method for setting a lighting apparatus condition according to the present invention are capable of obtaining a high-contrast image in order to carry out various subsequent processes such as an exposure treatment with excellent accuracy, even when the type of workpiece and the alignment mark are changed in various ways.

Further, the exposure apparatus, the digital exposure apparatus, and the exposure method of the present invention are capable of obtaining a high-contrast image in order to carry out a subsequent exposure treatment with excellent accuracy, even when the type of workpiece, the shape and form of the alignment mark, and the surface state of a substrate are changed in various ways.

### BRIEF DESCRIPTION OF THE DRAWINGS

FIG. 1 is a perspective view schematically showing the structure of an exposure apparatus according to an embodiment of the present invention;

FIG. 2 is a block diagram showing a control system of the exposure apparatus according to the embodiment;

FIG. 3 is an explanatory view showing a two-dimensional image formed by exposure heads of the exposure apparatus according to the embodiment;

FIG. 4 is a structural view showing the exposure head of the exposure apparatus according to the embodiment;

FIG. 5 is a structural view showing an alignment apparatus according to a first embodiment;

FIG. 6 is an explanatory view showing a process that uses a tone difference as quantitative data;

FIG. 7 is a flowchart of operations of the alignment apparatus according to the first embodiment;

FIG. 8A is an explanatory view showing a lighting apparatus placed at a lowermost position, FIG. 8B is an explanatory view showing the lighting apparatus moved upwardly by a predetermined distance, and FIG. 8C is an explanatory view showing the lighting apparatus placed at an uppermost position;

FIG. 9 is an explanatory view showing a process that uses a tone ratio of a histogram as quantitative data;

FIG. 10 is an explanatory view showing the contents of an information-recording table;

FIG. 11 is a flowchart of additional operations of the alignment apparatus according to the first embodiment;

FIG. 12 is a structural view showing an alignment apparatus according to a second embodiment;

FIG. 13A is an explanatory view showing lighting with blue light, FIG. 13B is an explanatory view showing lighting with green light, FIG. 13C is an explanatory view showing lighting with red light, FIG. 13D is an explanatory view showing lighting with white light, FIG. 13E is an explanatory view showing lighting with yellow light, FIG. 13F is an explanatory view showing lighting with magenta light, and FIG. 13G is an explanatory view showing lighting with cyan light;

FIG. 14 is a flowchart of operations of the alignment apparatus according to the second embodiment;

FIG. 15 is a flowchart of further operations of the alignment apparatus according to the second embodiment;

FIG. 16 is a structural view showing an alignment apparatus according to a third embodiment;

FIG. 17A is an explanatory view showing lighting with 1st-row light sources, FIG. 17B is an explanatory view showing lighting with 2nd-row light sources, and FIG. 17C is an explanatory view showing lighting with nth-row light sources;

FIG. 18 is a flowchart of operations of the alignment apparatus according to the third embodiment;

FIG. 19 is a flowchart of further operations of the alignment apparatus according to the third embodiment;

FIG. 20 is a structural view showing an alignment apparatus according to a fourth embodiment;

FIG. 21A is a perspective view showing an arrangement of light sources within a lighting apparatus of the alignment apparatus according to the fourth embodiment, and FIG. 21B is an explanatory view showing the arrangement as viewed from the bottom of the lighting apparatus;

FIG. 22 is a flowchart of operations of the alignment apparatus according to the fourth embodiment;

FIG. 23 is a first flowchart of further operations of the alignment apparatus according to the fourth embodiment;

FIG. 24 is a second flowchart of further operations of the alignment apparatus according to the fourth embodiment;

FIG. 25 is a structural view showing an alignment apparatus according to a fifth embodiment;

FIG. 26 is a structural view showing an alignment apparatus according to a sixth embodiment;

FIG. 27 is a structural view showing an alignment apparatus according to a seventh embodiment; and

FIG. 28 is a structural view showing an alignment apparatus according to an eighth embodiment.

### BEST MODE FOR CARRYING OUT THE INVENTION

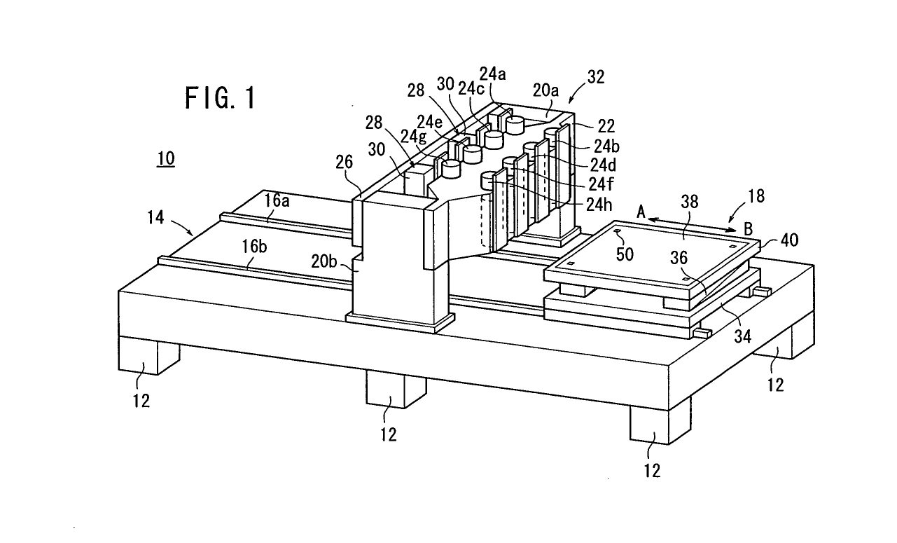

The light source unit for alignment, the alignment apparatus, the exposure apparatus, the digital exposure apparatus, the alignment method, the exposure method, and the method for setting a lighting apparatus condition according to the present invention shall be described below with reference to FIGS. 1 through 28, in which an embodiment of the exposure apparatus includes a spatial light modulation device, such as a digital micromirror device (DMD).

For example, an exposure apparatus 10 according to an embodiment of the present invention has a basic structure including a rectangular board 14 supported by six legs 12, two guide rails 16a, 16b formed on the board 14, a movable stage 18 that can be moved in the directions of arrows A and B along the guide rails 16a, 16b, columns 20a, 20b formed on the board 14, a scan plate 22 fixed between the columns 20a, 20b, eight exposure heads 24a to 24h positioned on and fixed to the scan plate 22, a camera plate 26 fixed between the columns 20a, 20b, and two respective alignment apparatuses 28 according to the present invention, which are positioned on and fixed to the camera plate 26. A double-housing head holder 32 is composed of at least the two columns 20a, 20b together with the scan plate 22.

The exposure apparatus 28 according to the present embodiment includes cameras 30 therein, such as CCD cameras, as shall be described hereinafter.

The movable stage 18 includes a movable base 34, which is moved along the guide rails 16a, 16b formed on the board 14, and an exposure table 40 for positioning and holding an exposure subject of a workpiece 38, formed on the upper surface of the movable base 34, with a lifting mechanism 36 therebetween. The workpiece 38 may comprise a substrate, a photosensitive material, a printed board, a substrate for a display device, a filter for a display device, or the like.

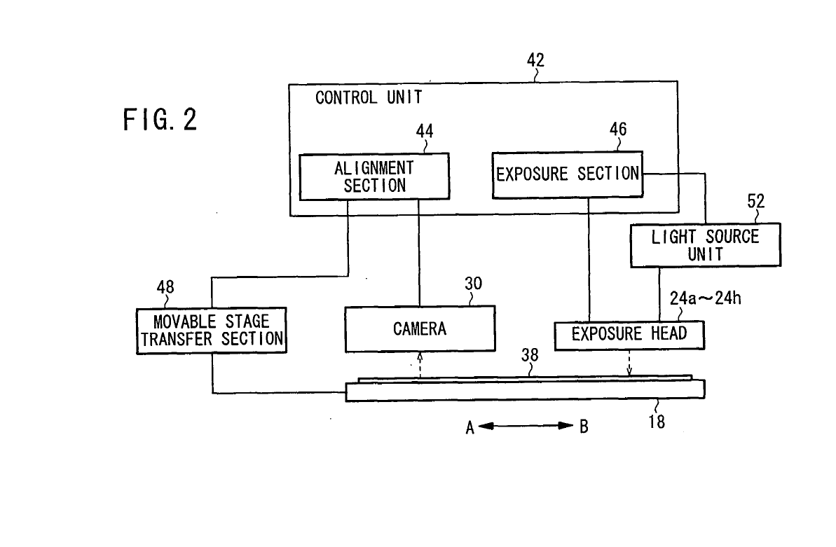

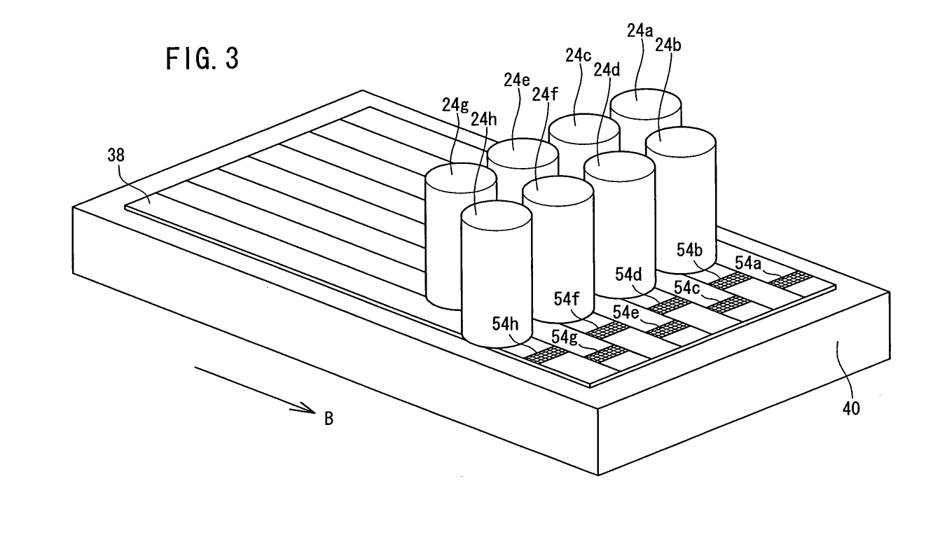

As shown in FIG. 2, a control unit 42 for the exposure apparatus 10 has an alignment section 44 and an exposure section 46. By using the alignment section 44, a movable stage transfer section 48 is controlled so as to move the movable stage 18, and an image recording position is aligned based on an image of alignment marks 50 (shown in FIG. 1) on the workpiece 38, wherein the image is taken by the cameras 30. By using the exposure section 46, a light source unit 52 and the exposure heads 24a to 24h are controlled, such that a desired image pattern (a combination of two-dimensional images) is recorded by exposure on the workpiece 38. In this case, as shown in FIG. 3, the exposure heads 24a to 24h are arranged in a 2-row zigzag configuration, wherein two-dimensional images, with a plurality of pixels, are simultaneously recorded on exposure areas 54a to 54h by the exposure heads 24a to 24h.

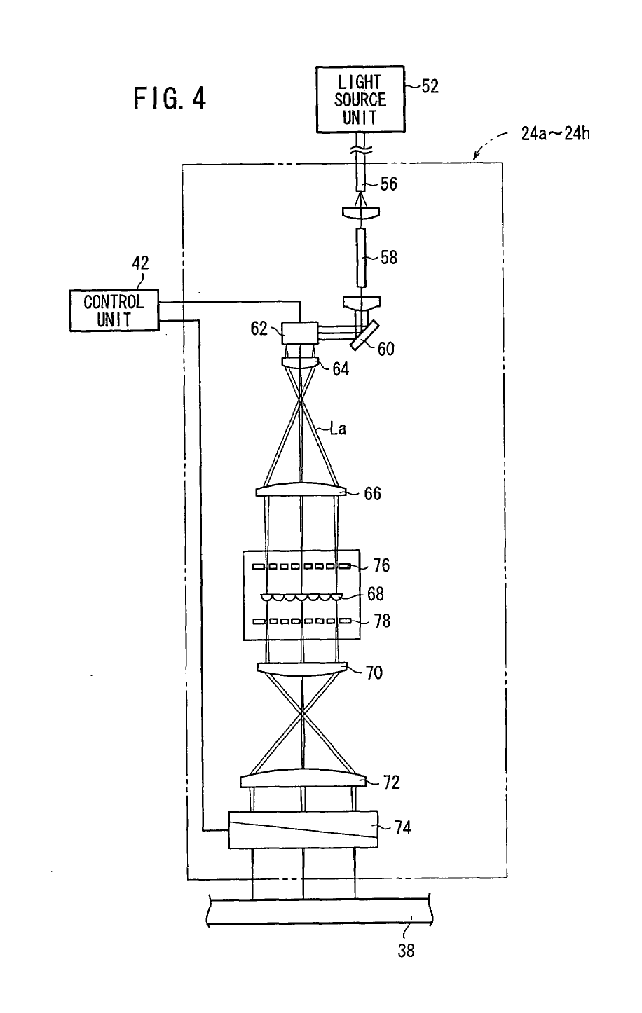

As shown in FIG. 4, for example, laser beams La are output from a plurality of semiconductor laser devices within the light source unit 52, wherein the laser beams La are multiplexed and introduced through an optical fiber 56 to each of the exposure heads 24a to 24h. A rod lens 58, a reflecting mirror 60, and a digital micromirror device (DMD) 62 are arranged, in this order, from an output end of the optical fiber 56, into which the laser beams La are introduced. The DMD 62 is a spatial light modulation device having a plurality of micromirrors for reflecting the laser beams La, wherein each of the micromirrors is driven based on image information under the control of a driving signal from the control unit 42.

Optical magnifying systems made up of first optical imaging lenses 64, 66, a microlens array 68 having a plurality of lenses corresponding to the micromirrors of the DMD 62, optical non-magnifying systems made up of second optical imaging lenses 70, 72, and a fine focusing mechanism made up of a prism pair 74 are arranged, in this order, along the path of the laser beams La reflected by the DMD 62. Microaperture arrays 76, 78 for removing stray light and controlling the diameter of the laser beams La are placed on the front and back of the microlens array 68.

Operations of the exposure apparatus 10 according to the present embodiment shall be described with reference to the drawings, including FIG. 1.

First, the movable stage transfer section 48 (shown in FIG. 2) is controlled by the alignment section 44 of the control unit 42, whereupon the movable stage 18, on which the workpiece 38 is positioned and fixed, is moved in the direction of the arrow A along the guide rails 16a, 16b on the board 14. When the movable stage 18 passes between the columns 20a, 20b, an image of the alignment marks 50, which are recorded at predetermined positions of the workpiece 38, is taken by the cameras 30 that are fixed to the camera plate 26 in the alignment apparatus 28.

Displacement or deformation, etc., of the workpiece 38 is detected from the image of the alignment marks 50, and correction data is formed by the control unit 42 for the image information that is to be recorded on the workpiece 38. Further, using the alignment section 44 of the control unit 42, the lifting mechanism 36 of the movable stage 18 is driven so as to move the exposure table 40 upward or downward, and the prism pair 74 (shown in FIG. 4) in each of the exposure heads 24a to 24h is controlled, so that the exposure heads 24a to 24h are focused on the workpiece 38.

Then, using the exposure section of the control unit 42, the movable stage 18 is moved in the direction of the arrow B, whereupon a two-dimensional image pattern (hereinafter referred to as an image pattern) is recorded on the workpiece 38 by the exposure heads 24a to 24h. The laser beams La output from the light source unit 52 are introduced through the optical fiber 56 to the exposure heads 24a to 24h, and then the laser beams La are introduced through the rod lens 58 and the reflecting mirror 60 to the DMD 62. The laser beams La are selectively reflected by the micromirrors in the DMD 62, under a control based on the image pattern information, whereby the laser beams La are magnified by the first optical imaging lenses 64, 66 and introduced through the microaperture array 76 to the microlens array 68. The laser beams La from the microlens array 68 pass through the second optical imaging lenses 70, 72 and the prism pair 74, and are formed into an image pattern on the workpiece 38.

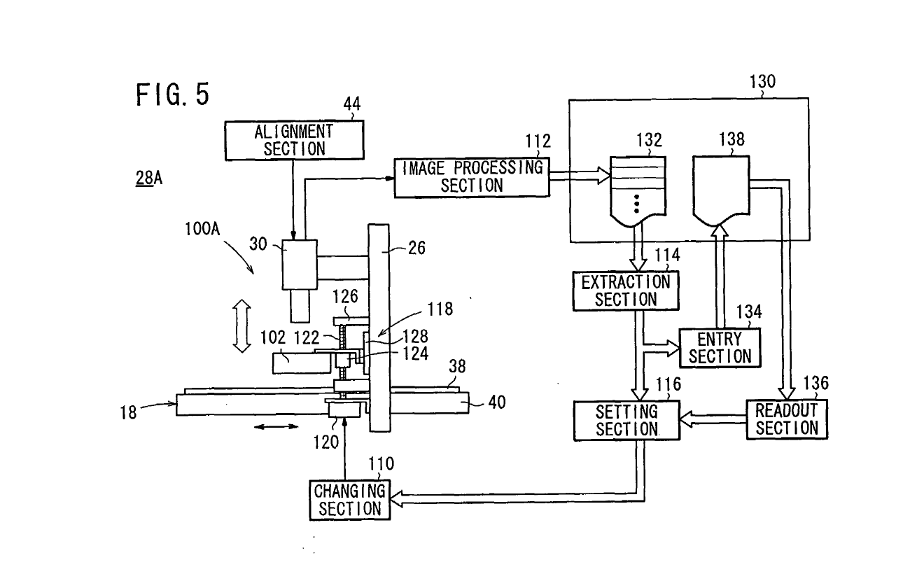

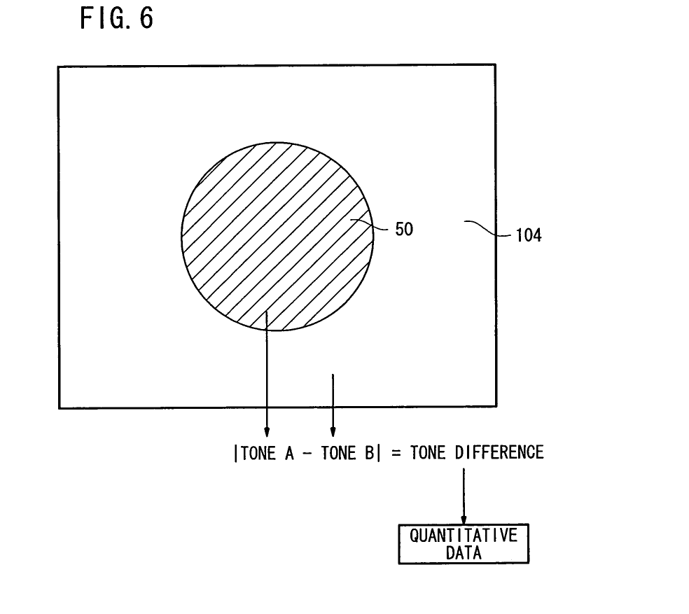

As shown in FIG. 5, an alignment apparatus 28A in accordance with a first embodiment incorporates an alignment light source unit 100A according to the first embodiment. The alignment light source unit 100A has a ring-shaped lighting apparatus 102, together with the above-described camera 30, which is controlled by the alignment section 44 of the control unit 42. As shown in FIG. 6, an image of the alignment mark 50 and the surrounding area 104 is taken by the camera 30, wherein the alignment mark 50 is irradiated with light by the lighting apparatus 102.

The alignment light source unit 100A includes a changing section 110, an image processing section 112, an extraction section 114, and a setting section 116, in addition to the camera 30 and the lighting apparatus 102.

The changing section 110 has a transfer mechanism 118 for moving the lighting apparatus 102 relatively closer to or farther away from the alignment mark 50.

In the present embodiment, as shown in FIG. 5, the transfer mechanism 118 includes a drive motor 120, a shaft (ball screw) 122 for converting rotational motion of the drive motor 120 into linear motion, a screw-driven part 124 that is fixed to the lighting apparatus 102 and moved along the shaft 122, a bearing 126 for the shaft 122, and a slide rail 128 for guiding the screw-driven part 124 upward or downward. The transfer mechanism 118 is such that rotational motion of the shaft 122 by the drive motor 120 is converted into linear motion of the screw-driven part 124, whereby the lighting apparatus 102 is moved upward or downward along the slide rail 128.

The transfer mechanism 118 is controlled by the changing section 110, and the lighting apparatus 102 is moved to a desired position based on information from the setting section 116.

In the image processing section 112, quantitative data on contrast between the alignment mark 50 and the surrounding area 104 is obtained, based on image information from the camera 30.

A plurality of distance values between the lighting apparatus 102 and the alignment mark 50 are obtained during relative displacement of the lighting apparatus 102 by the transfer mechanism 118. In the extraction section 114, an optimum distance, at which contrast is optimized, is selected from the distance values based on the quantitative data.

As described above, the changing section 110 is provided with information for moving the lighting apparatus 102 by the setting section 116. Further, the distance between the lighting apparatus 102 and the alignment mark 50 is set to the selected optimum distance by the setting section 116 during an alignment process using the alignment section 44. Thus, information for adjusting the distance between the lighting apparatus 102 and the alignment mark 50 to the optimum distance is transmitted from the setting section 116 to the changing section 110.

The image processing section 112, the extraction section 114, and the setting section 116 are contained within the alignment section 44 of the control unit 42.

Operations of the alignment apparatus 28A according to the first embodiment shall be described below with reference to FIGS. 5 to 9.

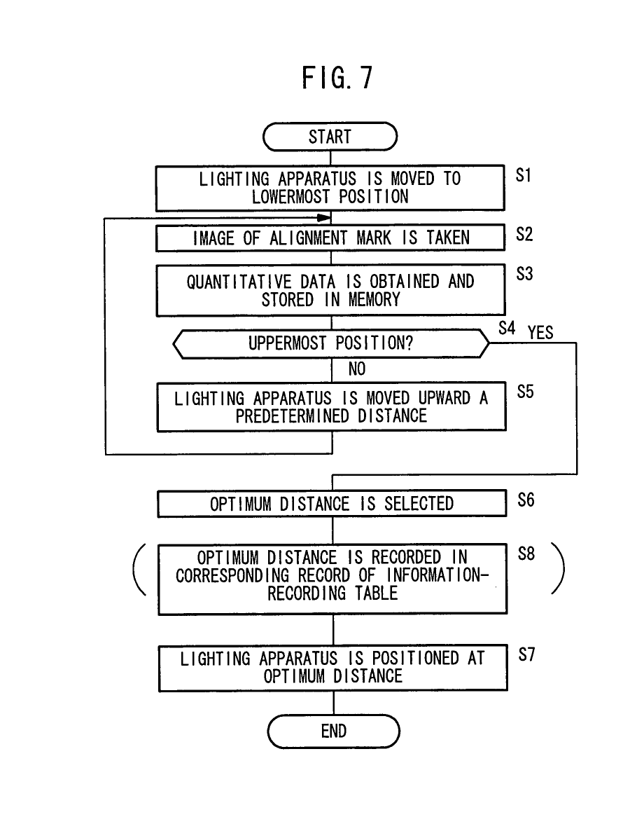

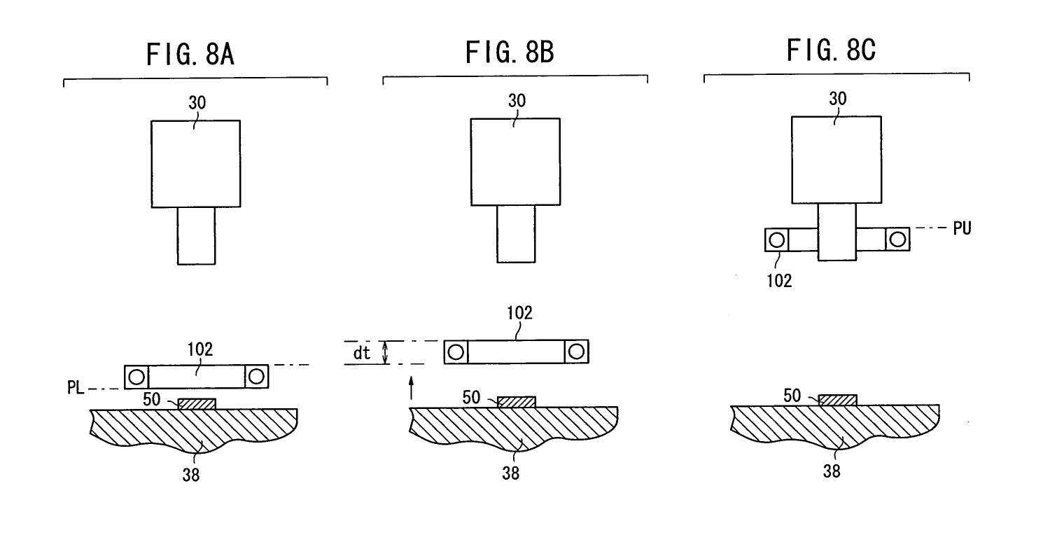

First, in step S1 of FIG. 7, information for positioning the lighting apparatus 102 at a lowermost position PL (shown in FIG. 8A) is transmitted from the setting section 116 to the changing section 110. The lighting apparatus 102 is moved to the lowermost position PL by the changing section 110, based on information from the setting section 116.

In step S2 of FIG. 7, an image of the alignment mark 50 is taken with the camera 30. Data of the image taken by the camera 30 is transmitted to the image processing section 112.

In step S3, quantitative data is obtained by one of the following first or second methods in the image processing section 112. The quantitative data is stored together with the distance information in a data file 132 of a memory 130 (shown in FIG. 5).

According to the first method, as shown in FIG. 6, a tone difference between a tone A of the alignment mark 50 and a tone B of the surrounding area 104 is obtained as quantitative data, based on the image data from the camera 30. In this method, the maximum value of the tone difference is used as such quantitative data.

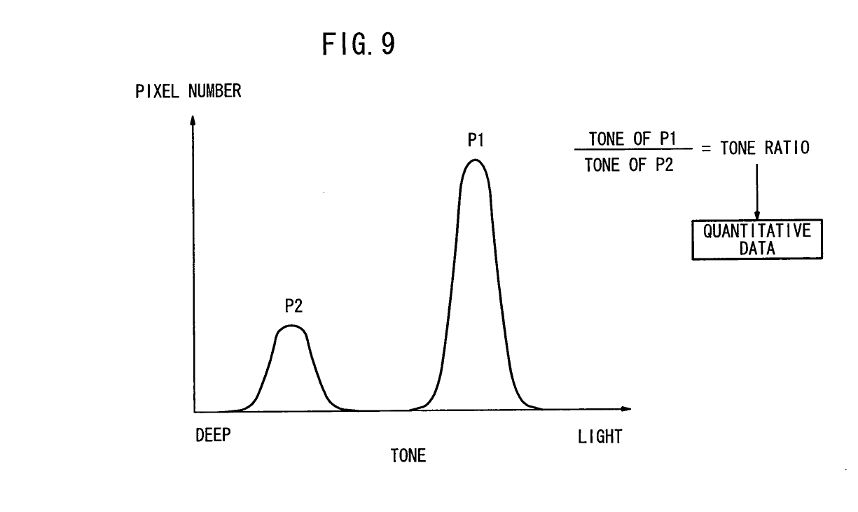

According to the second method, as shown in FIG. 9, a histogram showing a change of pixel number depending on tone is obtained based on the image data. A peak P1 having a maximum tone value and a peak P2 having a minimum tone value are extracted from a plurality of peaks in the histogram, and the tone ratio of the maximum tone value to the minimum tone value is obtained as quantitative data.

In step S4 of FIG. 7, it is judged whether the lighting apparatus 102 has reached an uppermost position PU (as shown in FIG. 8C) or not. For example, such a judgment may be made based on an interrupt signal (a signal indicating that the lighting apparatus 102 is in the uppermost position PU), provided by a position sensor or a proximity sensor (not shown).

In the case that the lighting apparatus 102 has not reached the uppermost position PU, in the next step S5, information for moving the lighting apparatus 102 upward by a predetermined distance dt (shown in FIG. 8B) is transmitted from the setting section 116 to the changing section 110. The lighting apparatus 102 is moved upward the distance dt by the changing section 110, based on the information from the setting section 116. Thus, the distance dt is added to the distance between the lighting apparatus 102 and the alignment mark 50.

Then, steps S2 to S5 are repeatedly carried out. Values of the distance are stored in the data file 132 together with corresponding quantitative data by repeating steps S2 to S5.

In the case that the lighting apparatus 102 is judged to have reached the uppermost position PU in step S4, the next step S6 is carried out. In step S6, in the extraction section 114, a distance corresponding to the quantitative data having the largest value, i.e., quantitative data with the maximum tone difference or the maximum tone ratio, is selected as the optimum distance from among a plurality of quantitative data stored in the data file 132.

In step S7, information for positioning the lighting apparatus 102 at the above selected optimum distance is introduced from the setting section 116 to the changing section 110. Thus, the lighting apparatus 102 is moved to the desired position and the optimum distance by the changing section 110, based on the information from the setting section 116.

Then, an alignment process is practically carried out using the alignment section 44 and the alignment apparatus 28A.

In a modified example of the process, as shown in FIG. 5, the alignment apparatus 28A includes an entry section 134 and a readout section 136, in addition to the changing section 110, the image processing section 112, the extraction section 114, and the setting section 116.

An information-recording table 138 is stored in the memory 130, in which the optimum distance corresponding to the type of workpiece 38 and the type of alignment mark 50 is recorded. The term “type of workpiece 38” implies the surface state, color, shape, etc., of the workpiece 38, whereas the term “type of alignment mark 50” implies the shape, form, etc., of the alignment mark 50.

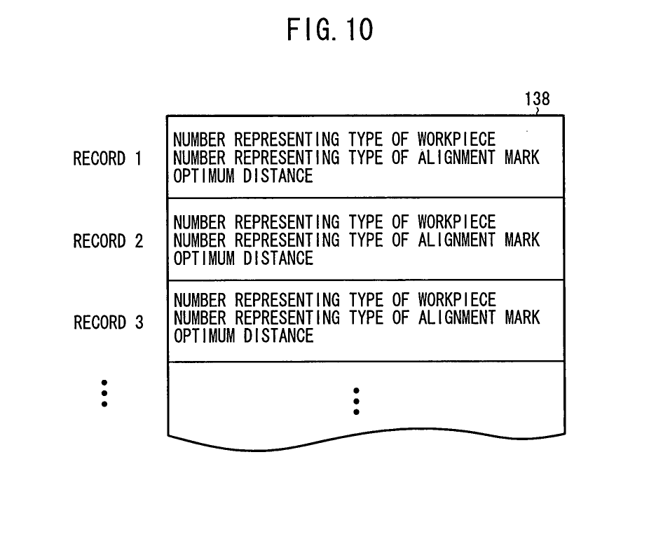

For example, as shown in FIG. 10, the information-recording table 138 contains a plurality of records, wherein a number representing the type of workpiece 38, a number representing the type of alignment mark 50, and the optimum distance are stored in each record. The number representing the type of workpiece 38 and the number representing the type of alignment mark 50 may be input by a user via a computer. Alternatively, an identification number recorded on the workpiece 38 may be read out from the image taken by the camera 30, and used as the number representing the type of workpiece 38. An identification number corresponding to the shape of the alignment mark 50 may be used as the number representing the type of alignment mark 50, wherein the shape is detected from the image of the alignment mark 50 by means of a pattern matching treatment, etc.

In step S8, as shown in parentheses in FIG. 7, the optimum distance selected in step S6 is recorded by the entry section in the corresponding record of the information-recording table. Thus, the optimum distance is stored in the record corresponding to the numbers representing the type of workpiece 38 and the type of alignment mark 50 being used.

Steps S1 to S7 (including step S8) are carried out repeatedly using a different workpiece 38 and/or a different alignment mark 50, whereby information of optimum distances corresponding to a plurality of workpieces 38 and alignment marks 50 are recorded in the information-recording table 138.

Thus, when alignment of a workpiece 38 is carried out after such recording, an optimum distance for the workpiece 38 and the alignment mark 50 can be retrieved from the information-recording table 138, so that the condition of the lighting apparatus can be set so as to correspond to the type of workpiece 38 and type of alignment mark 50, without performing steps S1 to S7 of FIG. 7 (including step S8).

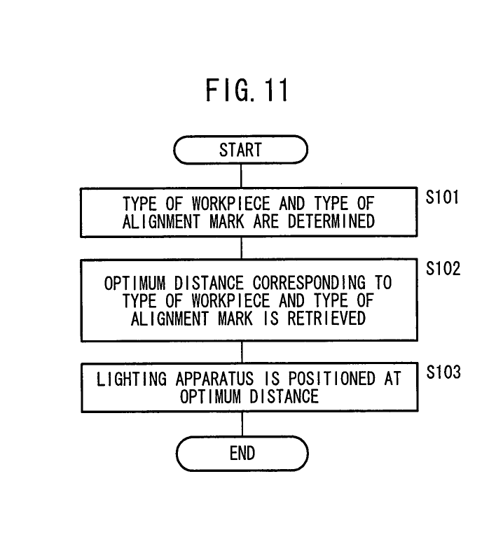

An example of such a process shall be described with reference to FIG. 11. First, in step S101, the type of workpiece 38 and the type of alignment mark 50 used are determined by readout or by input from the user via a computer.

In step S102, an optimum distance is retrieved by the readout section 136 from a record corresponding to the determined type of workpiece 38 and alignment mark 50, among the records contained in the information-recording table 138.

In step S103, information for positioning the lighting apparatus 102 at the readout optimum distance is transmitted from the setting section 116 to the changing section 110. The lighting apparatus 102 is positioned at the optimum distance by the changing section 110, based on information from the setting section 116.

Then, the alignment process is practically carried out using the alignment section 44 and the alignment apparatus 28A.

As described above, in the case of the alignment apparatus 28A according to the first embodiment, a high-contrast image can be obtained regardless of the type of workpiece 38 and the type of alignment mark 50, and various subsequent processes including an exposure treatment can be carried out with excellent accuracy. Thus, using the exposure apparatus 10 according to the above embodiment, a high-contrast image can be obtained by the alignment apparatus 28A according to the first embodiment, regardless of the type of workpiece 38 and the type of alignment mark 50, wherein a subsequent exposure treatment can be carried out with excellent accuracy.

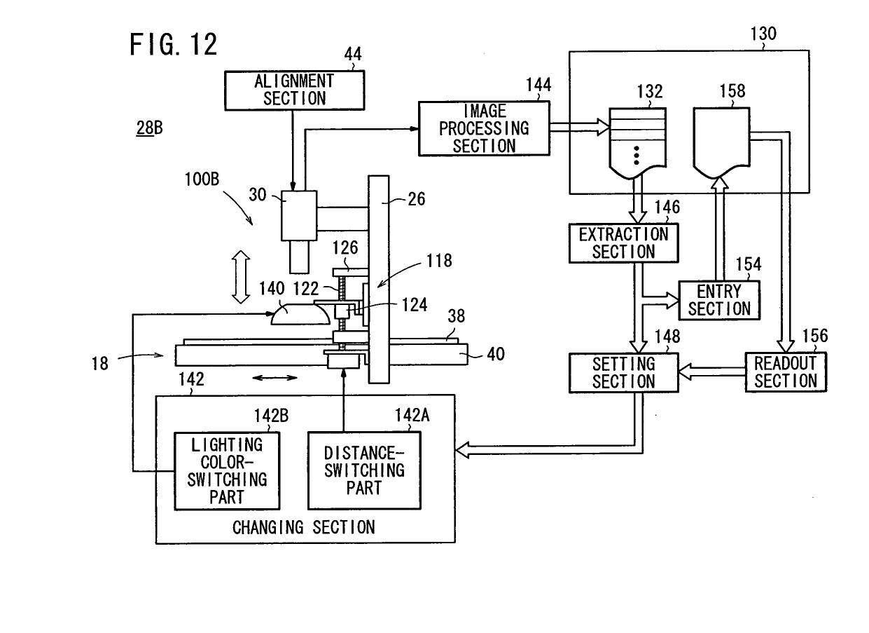

An alignment apparatus 28B according to a second embodiment shall be described below with reference to FIGS. 12 through 15.

As shown in FIG. 12, the alignment apparatus 28B according to the second embodiment includes an alignment light source unit 100B according to the second embodiment. The alignment light source unit 100B comprises a lighting apparatus 140, a changing section 142 for changing at least a lighting color of light output from the lighting apparatus 140 toward the alignment mark 50, an image processing section 144 for obtaining quantitative data on contrast between the alignment mark 50 and the surrounding area 104 based on image information from the camera 30, an extraction section 146 for selecting at least an optimum lighting color, under which contrast is optimized, from among a plurality of lighting colors changeable by the changing section 142 based on the quantitative data, and a setting section 148 for setting a lighting color of the lighting apparatus 140 to an optimum lighting color, during an alignment process using the alignment section 44.

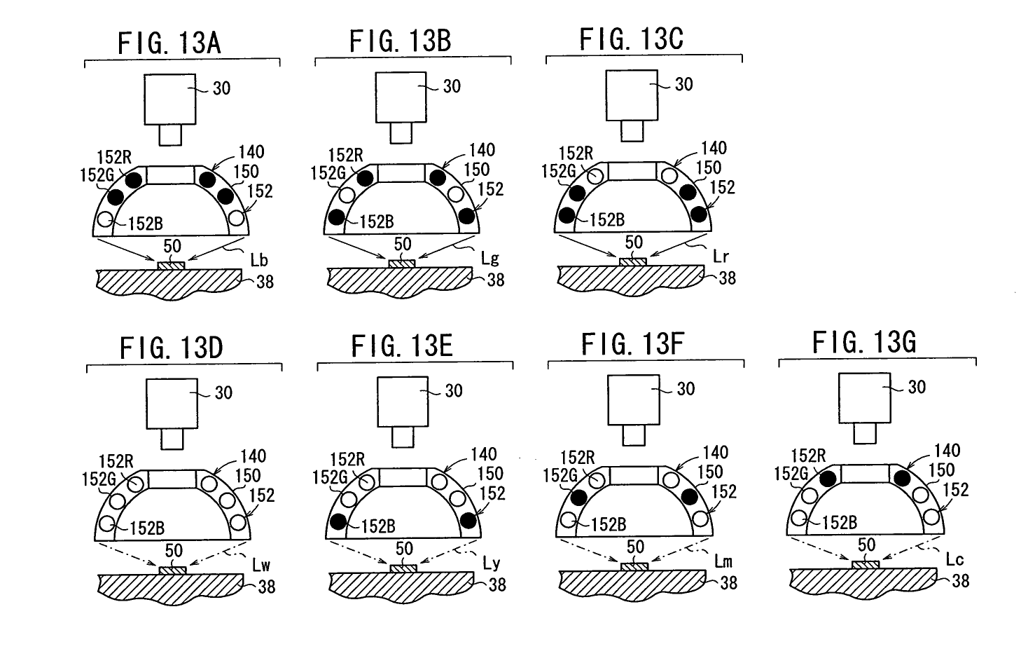

As shown in FIG. 13, the lighting apparatus 140 has a hollow casing 150 with a plurality of light sources 152 formed on the inner wall thereof. When a line of light sources 152 on an inner circumference around the center axis of the casing 150 (camera optical axis) is defined as a row, for example, a 1st-row, a 2nd-row, and a 3rd-row of light sources 152 are formed along the inner wall, in this order, from the bottom of the casing 150. The rows have different diameters, wherein the diameters of the 1st row, the 2nd row, and the 3rd row, are reduced in this order.

The 1st-row of light sources 152B emits blue light, the 2nd-row of light sources 152G emits green light, and the 3rd-row of light sources 152R emits red light. Thus, when the light sources 152 in each row are driven, the alignment mark 50 is irradiated with blue light Lb (shown in FIG. 13A), green light Lg (shown in FIG. 13B), or red light Lr (shown in FIG. 13C). Further, white light Lw (shown in FIG. 13D) is emitted when the light sources 152B, 152G, and 152R of all three rows are driven, yellow light Ly (shown in FIG. 13E) is emitted when the 2nd-row and 3rd-row light sources 152G and 152R are driven, magenta light Lm (shown in FIG. 13F) is emitted when the 1st-row and 3rd-row light sources 152B and 152R are driven, and cyan light Lc (shown in FIG. 13G) is emitted when the 1st-row and 2nd-row light sources 152B and 152G are driven.

The changing section 142 includes a distance-switching part 142A for driving a transfer mechanism 118, which is equivalent to that of the first embodiment, and a lighting color-switching part 142B for switching the drive objects of the lighting apparatus 140 to all or part of the 1st-row, the 2nd-row, and the 3rd-row light sources 152.

Two switching processes are carried out within the changing section 142. Thus, during the first switching process, the drive objects are switched to all or part of the 1st-row, the 2nd-row, and the 3rd-row light sources 152 by the lighting color-switching part 142B in order to change the lighting color.

In the second switching process, the distance between the lighting apparatus 140 and the alignment mark 50 is changed by the transfer mechanism 118, in the same manner as in the first embodiment, in addition to changing the lighting color by the lighting color-switching part 142B.

The image processing section 144 is the same as the image processing section 112 of the alignment apparatus 28A according to the first embodiment (shown in FIG. 5), and hence duplicate explanations of such features shall be omitted.

In the extraction section 146, when the first switching process is carried out by the changing section 142, a lighting color, under which contrast is optimized, is selected as an optimum lighting color from among a plurality of lighting colors, which are changeable by selecting the light sources 152 in the changing section 142, based on quantitative data from the image processing section 144. When the second switching process is carried out by the changing section 142, a lighting color condition and a distance condition between the lighting apparatus 140 and the alignment mark 50, under which contrast is optimized, are selected as optimum conditions (optimum lighting color and optimum distance) from among a plurality of lighting colors, which are changeable by selecting the light sources 152 in the changing section 142, and a plurality of distance values obtained upon relative displacement of the lighting apparatus 140 by the transfer mechanism 118, based on quantitative data from the image processing section 144.

When the first switching process is carried out, the changing section 142 is provided with information for changing the drive objects of the light sources 152 by the setting section 148, whereby the lighting color of the lighting apparatus 140 is set to a selected optimum lighting color during an alignment process using the alignment section 44. Thus, information for setting the lighting color of the lighting apparatus 140 to the optimum lighting color is transmitted from the setting section 148 to the changing section 142. On the other hand, when the second switching process is carried out, the changing section 142 is provided with information for changing the drive objects of the light sources 152 as well as information for moving the lighting apparatus 140 by the setting section 148, whereby the lighting color of the lighting apparatus 140 and the distance between the lighting apparatus 140 and the alignment mark 50 are set to selected optimum conditions during an alignment process using the alignment section 44. Thus, information for setting the lighting color of the lighting apparatus 140 to an optimum lighting color, and information for setting the distance between the lighting apparatus 140 and the alignment mark 50 to an optimum distance, are transmitted from the setting section 148 to the changing section 142.

Operations of the alignment apparatus 28B according to the second embodiment, particularly operations using the first switching process, shall be described below with reference to FIGS. 12 to 14. It should be noted that the lighting apparatus 140 initially is positioned at the lowermost position PL.

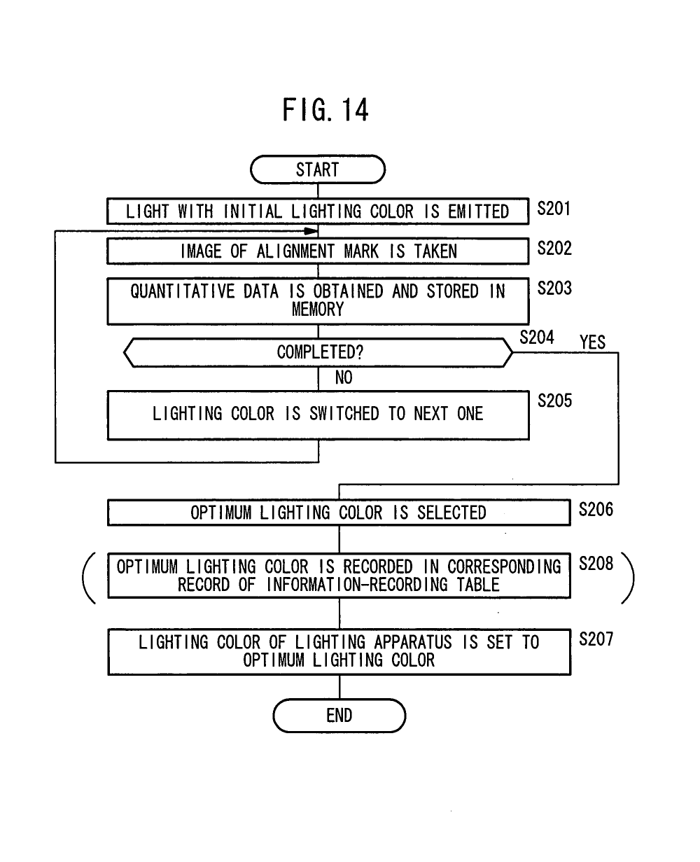

First, in step S201 of FIG. 14, light with a predetermined initial lighting color, e.g., blue light Lb shown in FIG. 13A, is emitted from the lighting apparatus 140. In this case, information for selecting the 1st-row light sources 152B is transmitted from the setting section 148 to the changing section 142. The 1st-row light sources 152B are selected as drive objects by the lighting color-switching part 142B of the changing section 142, based on information from the setting section 148. Thus, the initial light, i.e., blue light Lb, is emitted from the lighting apparatus 140.

In step S202, an image of the alignment mark 50 is taken by the camera 30. Data of the image taken by the camera 30 is transmitted to the image processing section 144.

In step S203, quantitative data is obtained in the image processing section 144 by the above method for obtaining a tone difference, or by the above method for obtaining a tone ratio from the histogram, and the quantitative data is stored in a data file 132 of the memory 130 together with lighting color information (e.g., the row number in this embodiment).

In step S204, it is judged whether all of the lighting colors have been used or not. In the event that all of the lighting colors have not been used, in the next step S205, information for switching the lighting color to a next color is transmitted from the setting section 148 to the changing section 142. The drive objects are switched to light sources corresponding to the next lighting color by the lighting color-switching part 142B of the changing section 142, based on information from the setting section 148. Thus, light with the selected lighting color is emitted from the lighting apparatus 140.

Then, steps S202 to S205 are repeatedly carried out. The lighting color is switched to blue, green, red, white, yellow, magenta, and cyan, in this order, wherein light having these colors is emitted successively from the lighting apparatus 140, by repeating steps S202 to S205. Information of the lighting colors is stored in the data file 132, together with corresponding quantitative data.

When it is confirmed that all of the lighting colors have been used in step S204, the next step S206 is carried out. In step S206, a lighting color corresponding to the quantitative data having the largest value, i.e., quantitative data with the maximum tone difference or the maximum tone ratio, is selected in the extraction section 146, from among a plurality of quantitative data stored in the data file 132, as an optimum lighting color.

In step S207, information is introduced from the setting section 148 to the changing section 142 for selecting light sources 152 corresponding to the selected optimum lighting color as drive objects. Thus, the drive objects are switched to light sources 152 corresponding to the optimum lighting color by the lighting color-switching part 142B of the changing section 142, based on information from the setting section 148.

Then, the alignment process is practically carried out using the alignment section 44 and the alignment apparatus 28B.

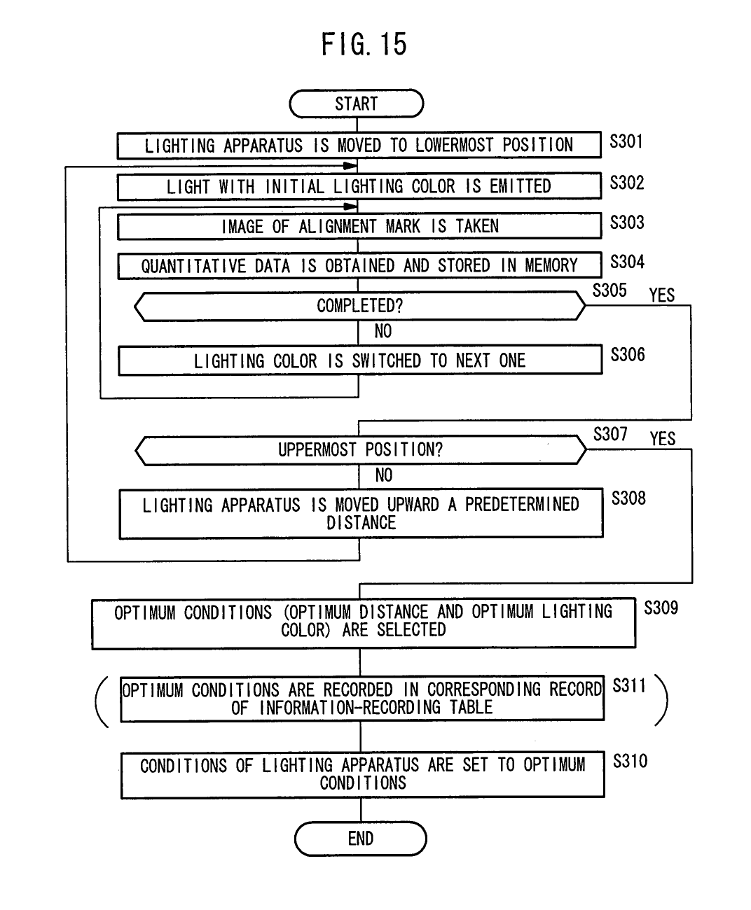

Operations of the alignment apparatus 28B according to the second embodiment, using the second switching process, shall be described below with reference to FIG. 15.

First, in step S301 of FIG. 15, information for positioning the lighting apparatus 140 at the lowermost position PL is transmitted from the setting section 148 to the changing section 142. The lighting apparatus 140 is moved to the lowermost position PL by the distance-switching part 142A of the changing section 142, based on information from the setting section 148.

Steps S302 to S306 are carried out in the same manner as steps S201 to S205, wherein information concerning the lighting colors and distances is stored in the data file 132, together with corresponding quantitative data.

In the event it is confirmed that all of the lighting colors have been used in step S305, the next step S307 is carried out. In step S307, it is judged whether or not the lighting apparatus 140 has reached the uppermost position PU.

In the case that the lighting apparatus 140 has not reached the uppermost position PU, information for moving the lighting apparatus 140 upward a predetermined distance is transmitted from the setting section 148 to the changing section 142 in the next step S308. The lighting apparatus 140 is then moved upwardly the predetermined distance by the distance-switching part 142A of the changing section 142, based on information from the setting section 148. Thus, the predetermined distance is added to the distance between the lighting apparatus 140 and the alignment mark 50.

Then, steps S302 to S308 are repeatedly carried out. By repeating steps S302 to S308, the lighting colors and distance values are stored in the data file 132, together with corresponding quantitative data.

In the case that the lighting apparatus 140 is judged to have reached the uppermost position PU in step S307, the next step S309 is carried out. In step S309, a distance value and a lighting color corresponding to quantitative data having the largest value, i.e., quantitative data with the maximum tone difference or the maximum tone ratio, are selected from among a plurality of quantitative data stored in the data file 132 as optimum conditions (optimum lighting color and optimum distance) in the extraction section 146.

In step S310, information for setting the conditions of the lighting apparatus 140 to the above selected optimum conditions is introduced from the setting section 148 to the changing section 142. Thus, the drive objects are switched to light sources 152 that correspond to the optimum lighting color by the lighting color-switching part 142B of the changing section 142, based on information from the setting section 148. Further, the lighting apparatus 140 is moved to a desired position at the optimum distance by the distance-switching part 142A of the changing section 142, based on information from the setting section 148.

Then, the alignment process is practically carried out using the alignment section 44 and the alignment apparatus 28B.

In a modified example of the processes, as shown in FIG. 12, the alignment apparatus 28B includes an entry section 154 and a readout section 156, in addition to the changing section 142, the image processing section 144, the extraction section 146, and the setting section 148.

An information-recording table 158 is stored in the memory 130, in which the optimum lighting color or optimum conditions (optimum lighting color and optimum distance) corresponding to the type of workpiece 38 and the type of alignment mark 50 are recorded. The basic structure of the information-recording table 158 is the same as that of the information-recording table 138 shown in FIG. 10, and hence duplicate explanations of such features shall be omitted.

In step S208, shown in parentheses in FIG. 14, or in step S311, shown in parentheses in FIG. 15, the optimum lighting color selected in step S206 or the optimum conditions selected in step S309 are recorded by the entry section 154 in the corresponding record of the information-recording table 158. Thus, the optimum lighting color or the optimum conditions are stored in a record corresponding to numbers representing the type of workpiece 38 and the type of alignment mark 50 being used.

Steps S201 to S207 (including step S208) or steps S301 to S310 (including step S311) are carried out repeatedly using a different workpiece 38 and/or a different alignment mark 50, whereby information of optimum lighting colors or optimum conditions corresponding to a plurality of workpieces 38 and alignment marks 50 are recorded in the information-recording table 158.

Thus, when alignment of a workpiece 38 is carried out after such recording, an optimum lighting color or optimum conditions for the workpiece 38 and alignment mark 50 can be retrieved from the information-recording table 158. Further, the condition of the lighting apparatus can be set to a condition that corresponds to the type of workpiece 38 and type of alignment mark 50, without performing steps S201 to S207 of FIG. 14 or steps S301 to S310 of FIG. 15.

As described above, in the case of using the alignment apparatus 28B according to the second embodiment as well, a high-contrast image can be obtained regardless of the type of workpiece 38 and the type of alignment mark 50, and various subsequent processes including an exposure treatment can be carried out with excellent accuracy.

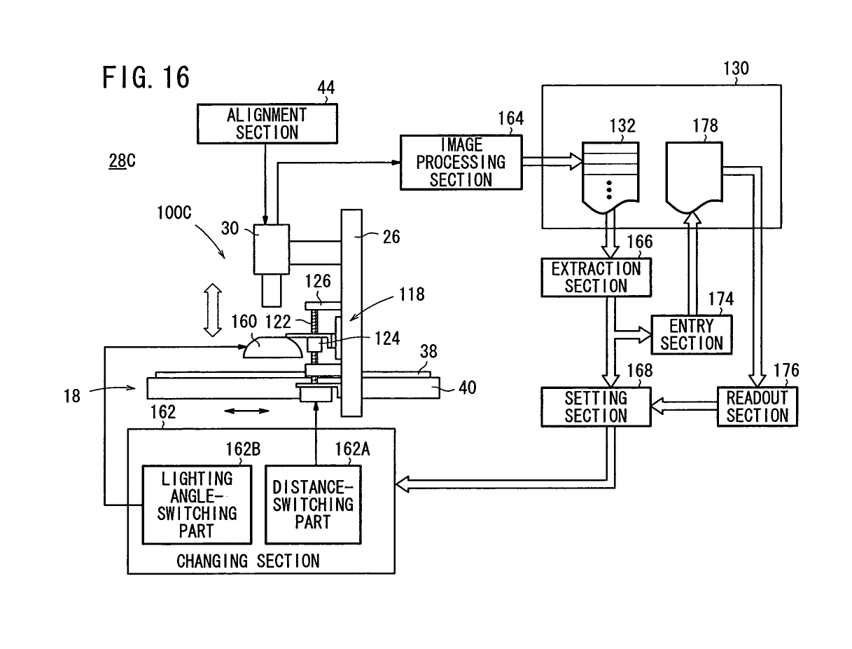

An alignment apparatus 28C according to a third embodiment shall be described below with reference to FIGS. 16 to 19.

As shown in FIG. 16, the alignment apparatus 28C according to the third embodiment includes an alignment light source unit 100C according to the third embodiment. The alignment light source unit 100C contains a lighting apparatus 160, a changing section 162 for changing at least the lighting angle of light emitted from the lighting apparatus 160 toward the alignment mark 50, an image processing section 164 for obtaining quantitative data on contrast between the alignment mark 50 and the surrounding area 104 based on image information from the camera 30, an extraction section 166 for selecting at least an optimum lighting angle, under which contrast is optimized, from among a plurality of lighting angles that are changeable by the changing section 162 based on quantitative data, and a setting section 168 for setting a lighting angle of the lighting apparatus 160 to an optimum lighting angle during an alignment process using the alignment section 44.

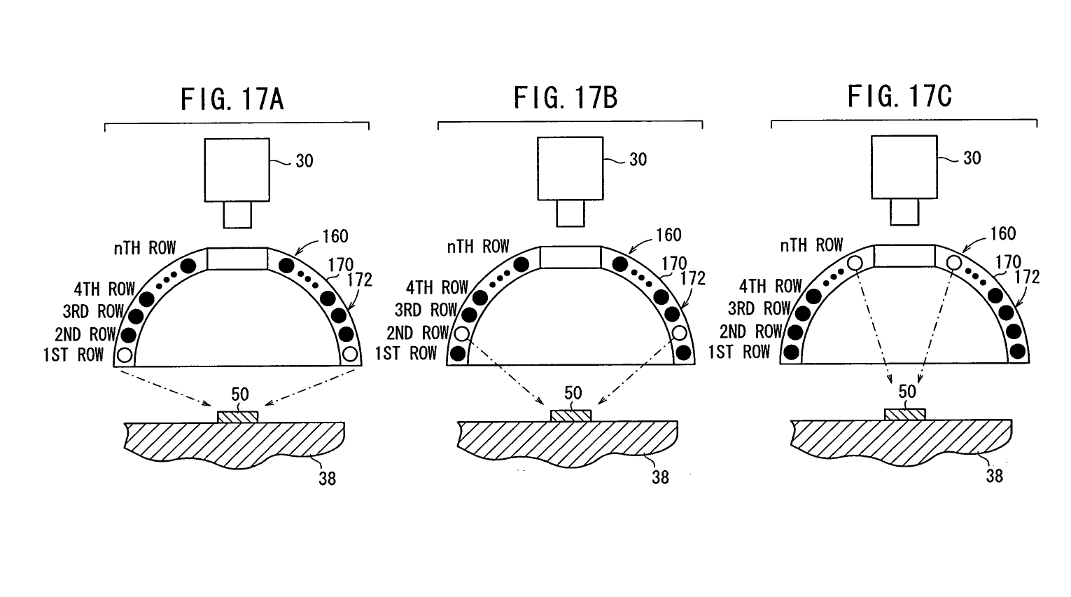

As shown in FIG. 17, the lighting apparatus 160 includes a hollow, dome-shaped casing 170, with a plurality of light sources 172 formed along the inner wall thereof. When a line of light sources 172 on an inner circumference around the center axis of the casing 170 (camera optical axis) is defined as a row, for example, the 1st-row, 2nd-row, . . . , and nth-row of the light sources 172 are formed along the inner wall, in this order, from the bottom of the casing 170.

Preferably, the distances from the 1st-row, 2nd-row, and nth-row light sources 172 to the alignment mark 50 are approximately equal.

The colors (lighting colors) of light emitted from the light sources 172 may be the same as well as varying according to the rows. For example, the light sources 172 may be such that those in the (3m+1)th row (m=0, 1, 2, . . . ) have a blue lighting color, those in the (3m+2)th row have a green lighting color, and those in the (3m+3)th row have a red lighting color.

The changing section 162 has a distance-switching part 162A for driving the transfer mechanism 118, which is equivalent to that of the first embodiment, along with a lighting angle-switching part 162B for switching drive objects of the lighting apparatus 160 to light sources 172 in one row from among the 1st, 2nd, . . . , and nth rows.

In the third embodiment, two switching processes also are carried out within the changing section 162. Thus, in the first switching process, drive objects are switched to light sources 172 in any one of the 1st, 2nd, . . . , and nth rows by the lighting angle-switching part 162B in order to change the lighting angle. When the colors of the lights emitted from the light sources 172 vary according to rows, the lighting color of the lighting apparatus 160 also is changed in the first switching process. Although, to simplify explanations, the third embodiment shall be described below without mentioning lighting color, lighting color is also practically considered, obviously.

In the second switching process, the distance between the lighting apparatus 160 and the alignment mark 50 is changed by the transfer mechanism 118, in the same manner as in the first embodiment, in addition to changing the lighting angle by the lighting angle-switching part 162B.

The image processing section 164 is the same as the image processing section 112 of the alignment apparatus 28A according to the first embodiment (as shown in FIG. 5), and thus duplicate explanations of such features shall be omitted.

In the extraction section 166, when the first switching process is carried out by the changing section 162, a lighting angle, under which contrast is optimized, is selected in the changing section 162 as an optimum lighting angle from among a plurality of lighting angles, which are changeable by selecting as drive objects the light sources 172, based on quantitative data from the image processing section 164. When the second switching process is carried out by the changing section 162, conditions of the lighting angle and distance between the lighting apparatus 160 and the alignment mark 50, under which contrast is optimized, are selected as optimum conditions (optimum lighting angle and optimum distance) from among a plurality of lighting angles, which are changeable by selecting the light sources 172 as drive objects in the changing section 162, together with a plurality of distance values obtained upon relative displacement of the lighting apparatus 160 by the transfer mechanism 118, based on quantitative data from the image processing section 164.

When the first switching process is carried out, the changing section 162 is provided with information for changing the light sources 172 by the setting section 168, whereby the lighting angle of the lighting apparatus 160 is set to a selected optimum lighting angle during an alignment process using the alignment section 44. Thus, information for setting the lighting angle of the lighting apparatus 160 to an optimum lighting angle is transmitted from the setting section 168 to the changing section 162. On the other hand, when the second switching process is carried out, the changing section 162 is provided with information for changing the light sources 172 together with information for moving the lighting apparatus 160 by the setting section 168, whereby the lighting angle of the lighting apparatus 160 and the distance between the lighting apparatus 160 and the alignment mark 50 are set to selected optimum conditions during an alignment process using the alignment section 44. Thus, information for setting the lighting angle of the lighting apparatus 160 to an optimum lighting angle, and information for setting the distance between the lighting apparatus 160 and the alignment mark 50 to an optimum distance, are transmitted from the setting section 168 to the changing section 162.

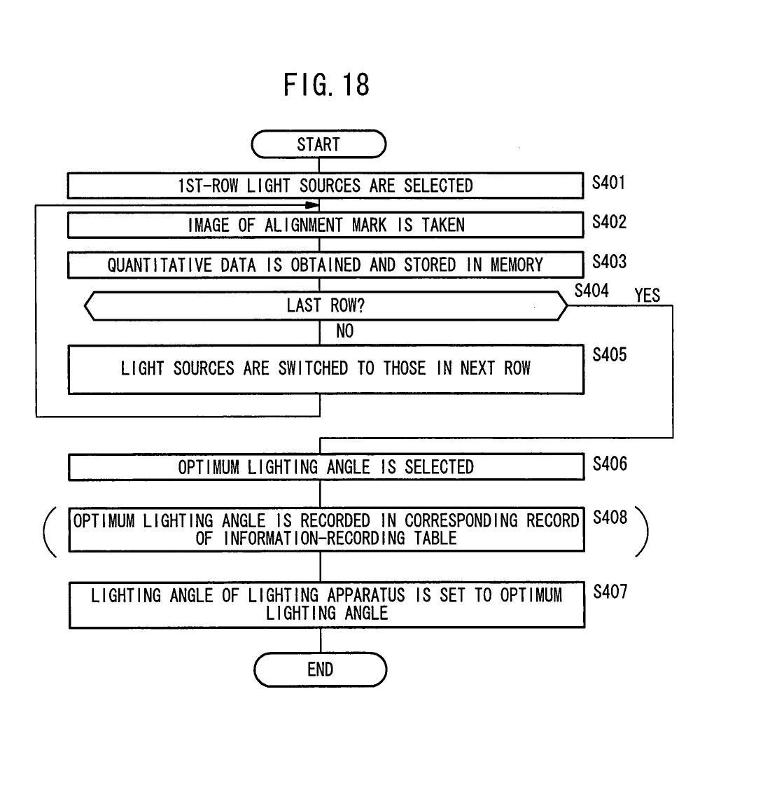

Operations of the alignment apparatus 28C according to the third embodiment, particularly operations in the case of using the first switching process, shall be described below with reference to FIG. 18. It should be noted that the lighting apparatus 160 is initially positioned at the lowermost position PL.

First, in step S401 of FIG. 18, information for selecting the 1st-row of light sources 172 is transmitted from the setting section 168 to the changing section 162. The 1st-row light sources 172 are selected as drive objects by the lighting angle-switching part 162B of the changing section 162, based on information from the setting section 168.

In step S402, an image of the alignment mark 50 is taken by the camera 30. The data of the image taken by the camera 30 is transmitted to the image processing section 164.

In step S403, quantitative data is obtained in the image processing section 164, either by the above method for obtaining a tone difference or by the above method for obtaining a tone ratio from the histogram, whereupon quantitative data is stored together with lighting angle information (e.g., the row number in this embodiment) in a data file 132 of the memory 130.

In step S404, it is judged whether the light sources 172 being used as drive objects are those in the last row (nth row) or not. For example, such a fact may be judged based on the number of switchings performed by the lighting angle-switching part 162B, or by a property of the switching signal.

In the case that the drive objects under use are not the light sources 172 in the last row (nth row), information for switching the drive objects to light sources 172 in the next row is transmitted from the setting section 168 to the changing section 162 in the next step S405. The drive objects are switched to light sources 172 in the next row by the lighting angle-switching part 162B of the changing section 162, based on information from the setting section 168. Thus, the lighting angle is changed by a certain degree.

Then, steps S402 to S405 are repeatedly carried out. Information concerning the lighting angles is stored in the data file 132, together with corresponding quantitative data, by repeating steps S402 to S405.

In the case that it is confirmed that the drive objects used are light sources 172 in the last row (the nth row) in step S404, the next step S406 is carried out. In step S406, a lighting angle corresponding to quantitative data having the largest value, i.e., quantitative data with the maximum tone difference or maximum tone ratio, is selected in the extraction section 166 from among a plurality of quantitative data stored in the data file 132 as indicating the optimum lighting angle.

In step S407, information for switching the drive objects to light sources 172 in a row corresponding to the selected optimum lighting angle is introduced from the setting section 168 to the changing section 162. Thus, the drive objects are switched by the lighting angle-switching part 162B of the changing section 162 to light sources 172 in a row corresponding to the optimum lighting angle, based on information from the setting section 168.

Then, the alignment process is practically carried out using the alignment section 44 and the alignment apparatus 28C.

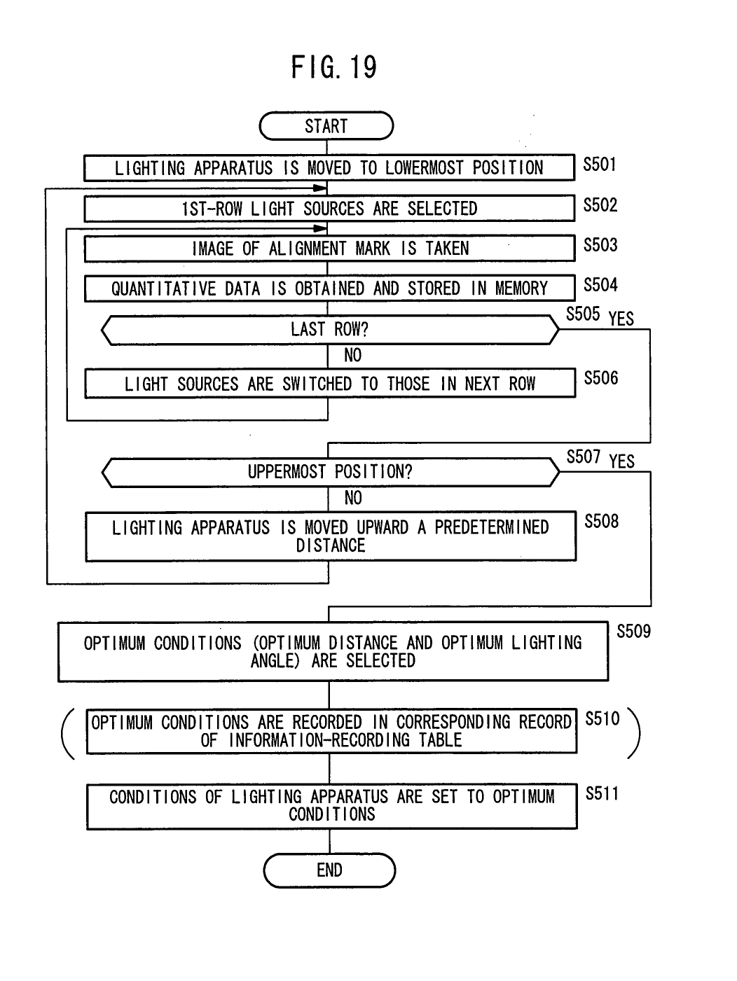

Operations of the alignment apparatus 28C, using the second switching process in the changing section 162, shall be described below with reference to FIG. 19.

First, in step S501 of FIG. 19, information for positioning the lighting apparatus 160 at the lowermost position PL is transmitted from the setting section 168 to the changing section 162. The lighting apparatus 160 is moved to the lowermost position PL by the distance-switching part 162A of the changing section 162, based on information from the setting section 168.

Steps S502 to S506 are carried out in the same manner as steps S401 to S405, whereby information concerning the lighting angles and distances is stored in the data file 132, together with corresponding quantitative data.

When it is confirmed that the light sources 172 in the last row (the nth row) have been used in step S505, the next step S507 is carried out. In step S507, it is judged whether the lighting apparatus 160 has reached the uppermost position PU or not.

In the case that the lighting apparatus 160 has not reached the uppermost position PU, in the next step S508, information for moving the lighting apparatus 160 upward a predetermined distance is transmitted from the setting section 168 to the changing section 162. The lighting apparatus 160 is moved upward the predetermined distance by the distance-switching part 162A of the changing section 162, based on information from the setting section 168.

Then, steps S502 to S508 are repeatedly carried out. The lighting angles and the distance values are stored in the data file 132, together with corresponding quantitative data by repeating steps S502 to S508.

In the case that the lighting apparatus 160 is judged to have reached the uppermost position PU in step S507, the next step S509 is carried out. In step S509, a lighting angle and distance corresponding to quantitative data having the largest value, i.e., quantitative data with the maximum tone difference or the maximum tone ratio, are selected in the extraction section 166 from among a plurality of quantitative data stored in the data file 132 as optimum conditions (optimum lighting angle and optimum distance).

In step S510, information for setting conditions of the lighting apparatus 160 to the above selected optimum conditions is introduced from the setting section 168 to the changing section 162. Thus, the drive objects are switched by the lighting angle-switching part 162B of the changing section 162 to light sources 172 of a row that corresponds to the optimum lighting angle, based on information from the setting section 168. Further, the lighting apparatus 160 is moved by the distance-switching part 162A of the changing section 162 to a desired position at the optimum distance, based on information from the setting section 168.

Then, the alignment process is practically carried out using the alignment section 44 and the alignment apparatus 28C.

In a modified example of the processes, as shown in FIG. 16, the alignment apparatus 28C includes an entry section 174 and a readout section 176, in addition to the changing section 162, the image processing section 164, the extraction section 166, and the setting section 168.

An information-recording table 178 is stored in the memory 130, in which an optimum lighting angle or optimum conditions (optimum lighting angle and optimum distance) corresponding to the type of workpiece 38 and the type of alignment mark 50 are recorded. The basic structure of the information-recording table 178 is the same as that of the information-recording table 138 shown in FIG. 10, and duplicate explanations of such features shall be omitted.

In step S408, as shown in parentheses in FIG. 18, or in step S511, shown in parentheses in FIG. 19, the optimum lighting angle selected in step S406 or the optimum conditions selected in step S509 are recorded by the entry section 174 in a corresponding record of the information-recording table 178. Thus, the optimum lighting angle or optimum conditions are stored in a record corresponding to numbers representing the type of the workpiece 38 and the type of alignment mark 50 being used.

Steps S401 to S407 (including step S408) or steps S501 to S510 (including step S511) are carried out repeatedly, using a different workpiece 38 and/or a different alignment mark 50, whereby information of optimum lighting angles or optimum conditions corresponding to a plurality of workpieces 38 and alignment marks 50 are recorded in the information-recording table 178.

Thus, when alignment of a workpiece 38 is carried out after such recording, an optimum lighting angle, or optimum conditions for the workpiece 38 and alignment mark 50, can be retrieved from the information-recording table 178, whereby conditions of the lighting apparatus can be set so as to correspond to the type of workpiece 38 and the type of alignment mark 50, without performing steps S401 to S407 of FIG. 18 or steps S501 to S510 of FIG. 19.

As described above, in the case of using the alignment apparatus 28C according to the third embodiment as well, a high-contrast image can be obtained regardless of the type of workpiece 38 and the type of alignment mark 50, and various subsequent processes including an exposure treatment can be carried out with excellent accuracy.

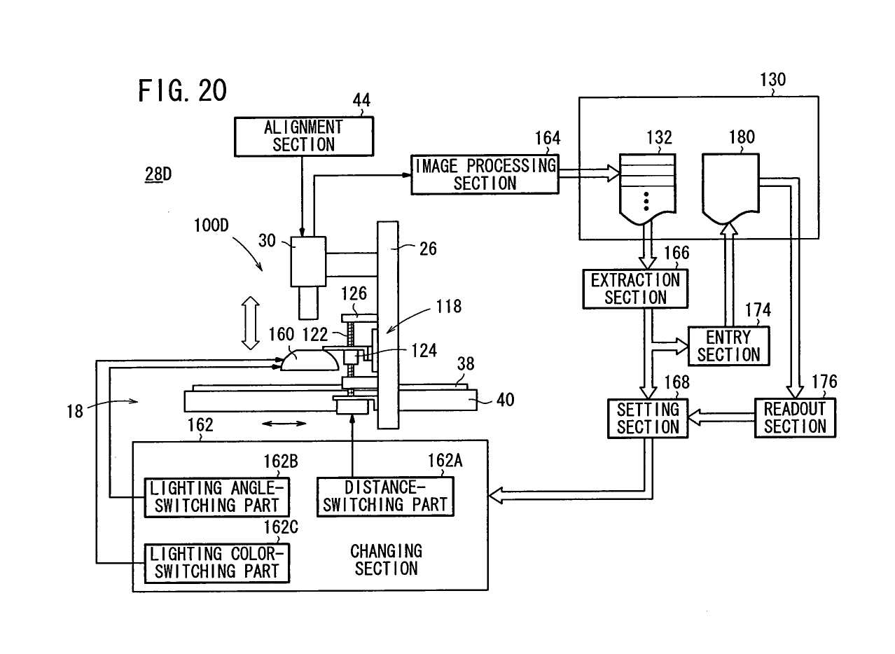

An alignment apparatus 28D according to a fourth embodiment shall be described below with reference to FIGS. 20 to 24.

As shown in FIG. 20, the alignment apparatus 28D according to the fourth embodiment has a structure similar to that of the alignment apparatus 28C according to the third embodiment, but differs from the alignment apparatus 28C concerning the features of the lighting apparatus 160.

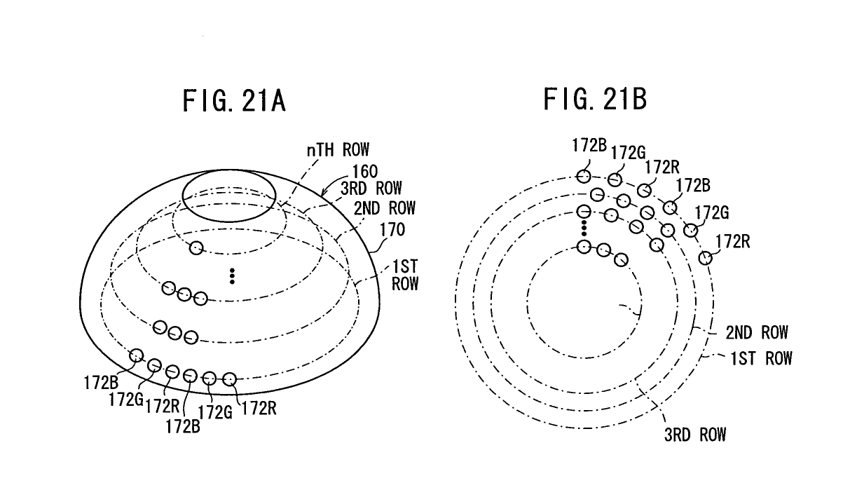

As shown in FIGS. 21A and 21B, a plurality of light sources 172 having different light colors are arranged in each row of the lighting apparatus 160. For example, light sources 172B having a blue light color, light sources 172G having a green light color, and light sources 172R having a red light color are arranged, in this order, in each row.

In the alignment apparatus 28D according to the fourth embodiment, a changing section 162 of an alignment light source unit 100D has a distance-switching part 162A for driving a transfer mechanism 118, which is the same as that of the first embodiment, a lighting angle-switching part 162B for switching drive objects of the lighting apparatus 160 to the light sources 172 in a given row from among the 1st, 2nd, . . . , and nth rows, so as to change the lighting angle, and a lighting color-switching part 162C for switching the drive objects to all or part of the light sources 172 in the selected one row in order to change the lighting color.

Two switching processes are carried out in the changing section 162. Thus, in the first switching process, by the lighting angle-switching part 162B, drive objects are switched to light sources 172 of one of the 1st, 2nd, . . . , and nth rows, in order to change the lighting angle. Further, by the lighting color-switching part 162C, the drive objects are switched to all or part of the light sources 172 in a selected one row in order to change the lighting color.

In the second switching process, the distance between the lighting apparatus 160 and the alignment mark 50 is changed by the transfer mechanism 118, in the same manner as in the first embodiment, in addition to changing the lighting angle by the lighting angle-switching part 162B, and changing the lighting color by the lighting color-switching part 162C.

In the extraction section 166, when the first switching process is carried out by the changing section 162, conditions for the lighting angle and lighting color, under which contrast is optimized, are selected as first optimum conditions (optimum lighting angle and optimum lighting color) from among a plurality of lighting angles that are changeable by switching the row in the lighting angle-switching part 162B, as well as a plurality of lighting colors that are changeable by switching the light sources 172 in the lighting color-switching part 162C, based on quantitative data from the image processing section 164. When the second switching process is carried out by the changing section 162, conditions of lighting angle, lighting color, and distance between the lighting apparatus 160 and the alignment mark 50, under which contrast is optimized, are selected as second optimum conditions (optimum lighting angle, optimum lighting color, and optimum distance) from among the plurality of lighting angles, the plurality of lighting colors, and the plurality of distance values obtained upon relative displacement of the lighting apparatus 160 by the transfer mechanism 118, based on quantitative data from the image processing section 164.

When the first switching process is carried out, the changing section 162 is provided from the setting section 168 with information for changing the row and the drive objects of the light sources 172, wherein the lighting angle and the lighting color of the lighting apparatus 160 are set to the selected first optimum conditions during an alignment process using the alignment section 44. Thus, information for setting the lighting angle of the lighting apparatus 160 to the optimum lighting angle, and information for setting the lighting color of the lighting apparatus 160 to the optimum lighting color, are transmitted from the setting section 168 to the changing section 162. On the other hand, when the second switching process is carried out, the changing section 162 is provided with information from the setting section 168 for changing the row and drive objects of the light sources 172, along with information for moving the lighting apparatus 160, wherein the lighting angle and the lighting color of the lighting apparatus 160, as well as the distance between the lighting apparatus 160 and the alignment mark 50, are set to the selected second optimum conditions during an alignment process using the alignment section 44. Thus, information for setting the lighting angle of the lighting apparatus 160 to the optimum lighting angle, information for setting the lighting color of the lighting apparatus 160 to the optimum lighting color, and information for setting the distance between the lighting apparatus 160 and the alignment mark 50 to the optimum distance, are transmitted from the setting section 168 to the changing section 162.

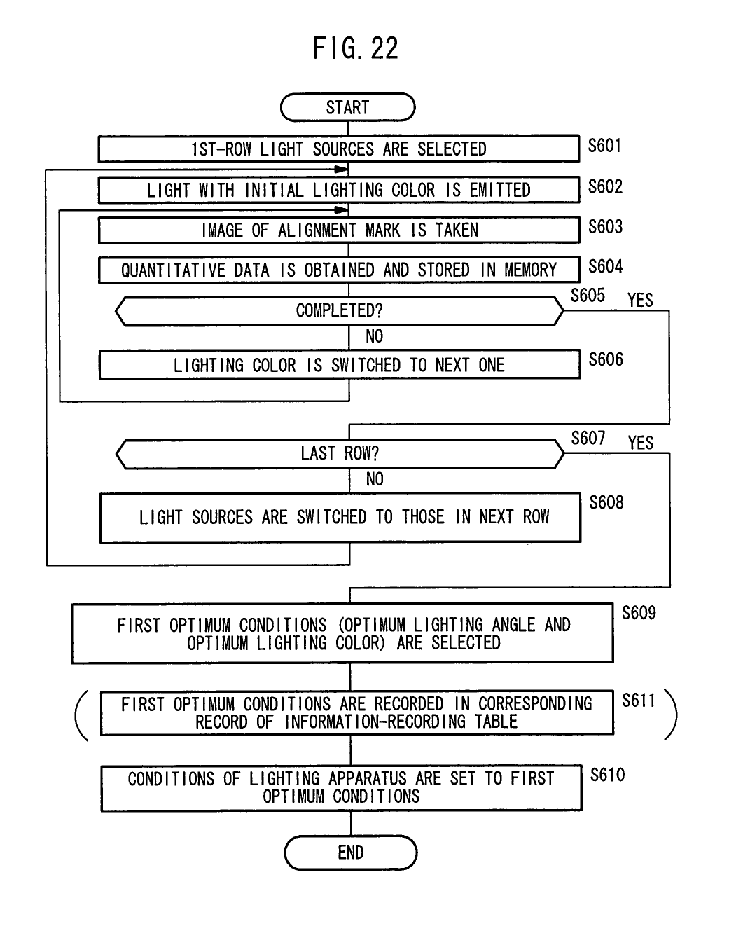

Operations of the alignment apparatus 28D according to the fourth embodiment, particularly operations when using the first switching process, shall be described below with reference to FIG. 22. It should be noted that the lighting apparatus 160 is initially positioned at the lowermost position PL.

First, in step S601, information for selecting the 1st-row light sources 172 is transmitted from the setting section 168 to the changing section 162. Thus, the 1st-row light sources 172 are selected as drive objects by the lighting angle-switching part 162B of the changing section 162, based on information from the setting section 168.

In step S602, information for selecting the drive objects for emitting light with a predetermined initial lighting color, such as a blue color, from the selected 1st-row light sources 172 is transmitted from the setting section 168 to the changing section. The drive objects are switched by the lighting color-switching part 162C of the changing section 162 to the light sources 172B, for emitting blue light from among the selected 1st-row light sources 172, based on the information from the setting section 168. Thus, the initial light, i.e., blue light, is emitted from the lighting apparatus 160.

In step S603, an image of the alignment mark 50 is taken by the camera 30. The data of the image taken by the camera 30 is transmitted to the image processing section 164.

In step S604, quantitative data is obtained in the image processing section 164 by either of the above methods for obtaining a tone difference or for obtaining a tone ratio from the histogram, and quantitative data is stored in a data file of a memory, together with lighting angle information (e.g., the row number in this embodiment) and lighting color information (e.g., the light source number).

In step S605, it is judged whether all the lighting colors have been used or not. In the event that all of the lighting colors have not been used, in the following step S606, information for switching the lighting color to a next color is transmitted from the setting section 168 to the changing section 162. The drive objects are switched to light sources 172 corresponding to the next lighting color by the lighting color-switching part 162C of the changing section 162, based on information from the setting section 168. Thus, light having the selected lighting color is emitted from the lighting apparatus 160.

Then, steps S603 to S606 are repeatedly carried out. By repeating steps S603 to S606, the lighting color is switched to blue, green, red, white, yellow, magenta, and cyan, in this order, and light having each of these colors is emitted successively from the lighting apparatus 160. Information concerning the lighting angle and the lighting colors is stored in the data file 132, together with corresponding quantitative data.

When it is confirmed that all of the lighting colors have been used in step S605, the next step S607 is carried out. In step S607, it is judged whether the light sources 172 used as drive objects are light sources in the last row (the nth row).

In the event that the drive objects used are not the light sources 172 from the last row (the nth row), in the next step S608, information for switching the drive objects to light sources 172 from the next row is transmitted from the setting section 168 to the changing section 162. The drive objects are switched to light sources 172 in the next row by the lighting angle-switching part 162B of the changing section 162, based on information from the setting section 168. Thus, the lighting angle is changed by a certain degree.

Then, steps S602 to S608 are repeatedly carried out. By repeating steps S602 to S608, information concerning the lighting angles and colors is stored in the data file 132, together with corresponding quantitative data.

When it is confirmed that the drive objects used are the light sources 172 within the last row (nth row) in step S607, the next step S609 is carried out. In step S609, a lighting angle and a lighting color, corresponding to the quantitative data having the largest value, i.e., quantitative data with the largest tone difference or the largest tone ratio, is selected in the extraction section 166 from among the plurality of quantitative data stored in the data file 132 as first optimum conditions (optimum lighting angle and optimum lighting color).

In step S610, information for switching the drive objects to light sources 172 in a row that corresponds to the selected optimum lighting angle, and information for switching the drive objects to light sources 172 that correspond to the selected optimum lighting color, are introduced from the setting section 168 to the changing section 162. Thus, the row of drive objects is switched by the lighting angle-switching part 162B of the changing section 162 to a row corresponding to the optimum lighting angle, based on information from the setting section 168, and the drive objects are switched by the lighting color-switching part 162C of the changing section 162 to the light sources 172 that correspond to the optimum lighting color, based on information from the setting section 168.

Then, the alignment process is practically carried out using the alignment section 44 and the alignment apparatus 28D.

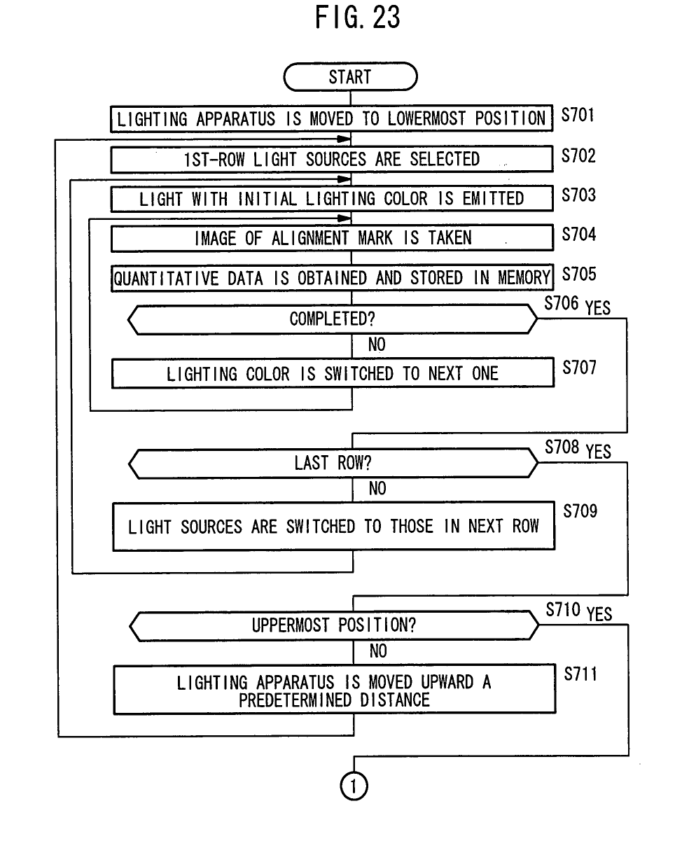

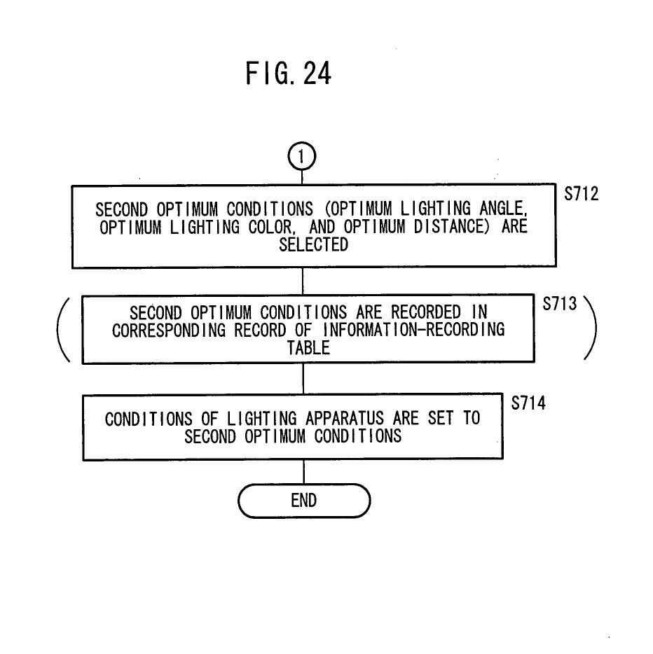

Operations of the alignment apparatus 28D, using the second switching process within the changing section 162, shall be described below with reference to FIGS. 23 and 24.

First, in step S701 of FIG. 23, information for positioning the lighting apparatus 160 at the lowermost position PL is transmitted from the setting section 168 to the changing section 162. The lighting apparatus 160 is moved to the lowermost position PL by the distance-switching part 162A of the changing section 162, based on information from the setting section 168.

Steps S702 to S709 are carried out in the same manner as steps S601 to S608, whereby information of lighting angles, lighting colors, and distances are stored in the data file 132, together with corresponding quantitative data.

When it is confirmed that the light sources 172 in the last row (the nth row) are used in step S708, the next step S710 is carried out. In step S710, it is judged whether the lighting apparatus 160 has reached the uppermost position PU or not.

In the event that the lighting apparatus 160 has not yet reached the uppermost position PU, in the following step S711, information for moving the lighting apparatus 160 upward a predetermined distance is transmitted from the setting section 168 to the changing section 162. The lighting apparatus 160 thus is moved upward a predetermined distance by the changing section 162, based on information from the setting section 168.

Then, steps S702 to S711 are repeatedly carried out. Hence, by repeating steps S702 to S711, lighting angles, lighting colors, and distance values are stored in the data file 132, together with corresponding quantitative data.

When the lighting apparatus 160 is judged to have reached the uppermost position PU in step S710, the next step S712 of FIG. 24 is carried out. In step S712, a lighting angle, a lighting color, and a distance, corresponding to quantitative data with the largest value, i.e., quantitative data with the maximum tone difference or the maximum tone ratio, are selected in the extraction section 166 from among a plurality of quantitative data stored in the data file 132 as second optimum conditions (optimum lighting angle, optimum lighting color, and optimum distance).

In step S714, information for setting the conditions of the lighting apparatus 160 to the above selected second optimum conditions is introduced from the setting section 168 to the changing section 162. Thus, based on information from the setting section 168, the row of drive objects is switched by the lighting angle-switching part 162B of the changing section 162 to a row that corresponds to the optimum lighting angle. The drive objects are switched to the light sources 172 corresponding to the optimum lighting color by the lighting color-switching part 162C of the changing section 162, based on information from the setting section 168. Further, the lighting apparatus 160 is moved to a desired position corresponding to the optimum distance by the distance-switching part 162A of the changing section 162, based on information from the setting section 168.

Then, the alignment process is practically carried out using the alignment section 44 and the alignment apparatus 28D.

In a modified example of the processes, as shown in FIG. 20, the alignment apparatus 28D includes an entry section 174 and a readout section 176, in addition to the changing section 162, the image processing section 164, the extraction section 166, and the setting section 168.

An information-recording table 180 is stored in the memory 130, in which the first optimum conditions (optimum lighting angle and optimum lighting color) or the second optimum conditions (optimum lighting angle, optimum lighting color, and optimum distance) corresponding to the type of workpiece 38 and the type of alignment mark 50 are recorded. The basic structure of the information-recording table 180 is the same as that of the information-recording table 138 shown in FIG. 10, and duplicate explanations of such features shall be omitted.

In step S611, shown in parenthesis in FIG. 22, or step S713, shown in parentheses in FIG. 24, the first or second optimum conditions selected in step S611 or S713 are recorded by the entry section 174 within the corresponding record of the information-recording table 180. Thus, the selected first or second optimum conditions are stored in the record, corresponding to the numbers representing the type of workpiece 38 and the type of alignment mark 50 being used.

Steps S601 to S610 (including step S611) or steps S701 to S714 (including step S713) are carried out repeatedly, using a different workpiece 38 and/or a different alignment mark 50, so that information of the first or second optimum conditions, corresponding to a plurality of workpieces 38 and alignment marks 50, are recorded within the information-recording table 180.

Thus, when alignment of a workpiece 38 is carried out after such recording, the first or second optimum conditions for the workpiece 38 and alignment mark 50 can be retrieved from the information-recording table 180, and the condition of the lighting apparatus can be set to a condition that corresponds to the type of workpiece 38 and type of alignment mark 50, without performing steps S601 to S610 of FIG. 22 or steps S701 to S714.

As described above, in the case of using the alignment apparatus according to the fourth embodiment as well, a high-contrast image can be obtained regardless of the type of workpiece 38 and the type of alignment mark 50, and various subsequent processes including an exposure treatment can be carried out with excellent accuracy.

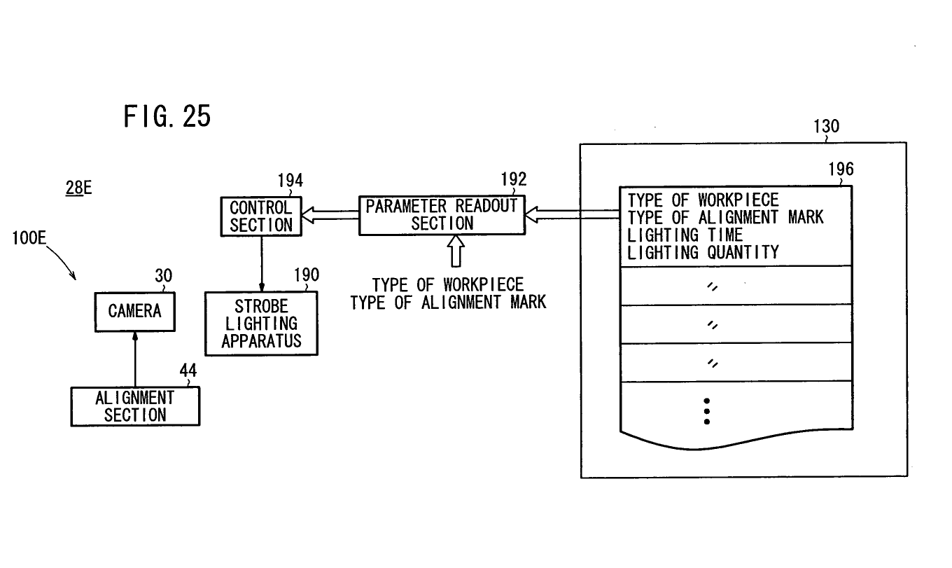

As shown in FIG. 25, in an alignment apparatus 28E according to a fifth embodiment, an alignment light source unit 100E includes a camera 30, a strobe lighting apparatus 190, a memory 130, a parameter readout section 192, and a control section 194.

An information-recording table 196 is stored in the memory 130, in which parameters including at least the strobe lighting times and strobe lighting quantities of the strobe lighting apparatus 190 corresponding to the type of workpiece 38 and the type of alignment mark 50 are recorded.

The parameter corresponding to the type of workpiece 38 and the type of alignment mark 50 used is retrieved from the information-recording table 196 by the parameter readout section 192.

Driving of the strobe lighting apparatus 190 is controlled by the control section 194, based on the read-out parameter, during an alignment process using the alignment section 44.

Thus, according to the present embodiment, a high-contrast image can be obtained, regardless of the type of workpiece 38 and type of alignment mark 50, whereby various subsequent processes including an exposure treatment can be carried out with excellent accuracy.

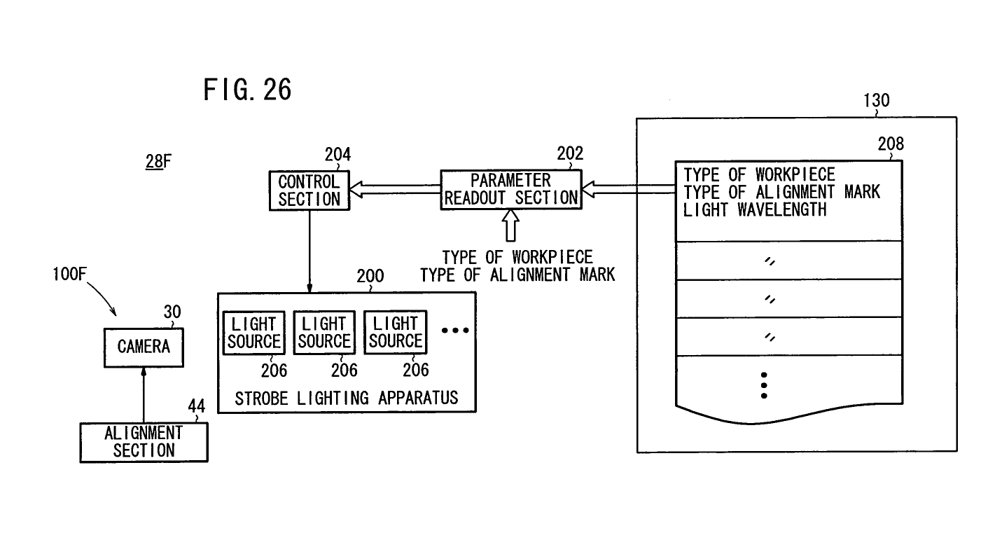

As shown in FIG. 26, in an alignment apparatus 28F according to a sixth embodiment, an alignment light source unit 100F includes a camera 30, a strobe lighting apparatus 200, a memory 130, a parameter readout section 202, and a control section 204.

The strobe lighting apparatus 200 utilizes a plurality of strobe light sources 206 having different light wavelengths.

An information-recording table 208 is stored in the memory 130, in which parameters including at least the light wavelengths corresponding to the type of workpiece 38 and the type of alignment mark 50 are recorded.

The parameter corresponding to the type of workpiece 38 and the type of alignment mark 50 being used is retrieved from the information-recording table 208 by the parameter readout section 202.

The strobe light source 206, corresponding to the light wavelength of the read-out parameter, is selected from among the plural light sources and driven by the control section 204 during an alignment process using an alignment section 44.

Thus, in this embodiment as well, a high-contrast image can be obtained, regardless of the type of workpiece 38 and alignment mark 50, and various subsequent processes, including an exposure treatment, can be carried out with excellent accuracy.

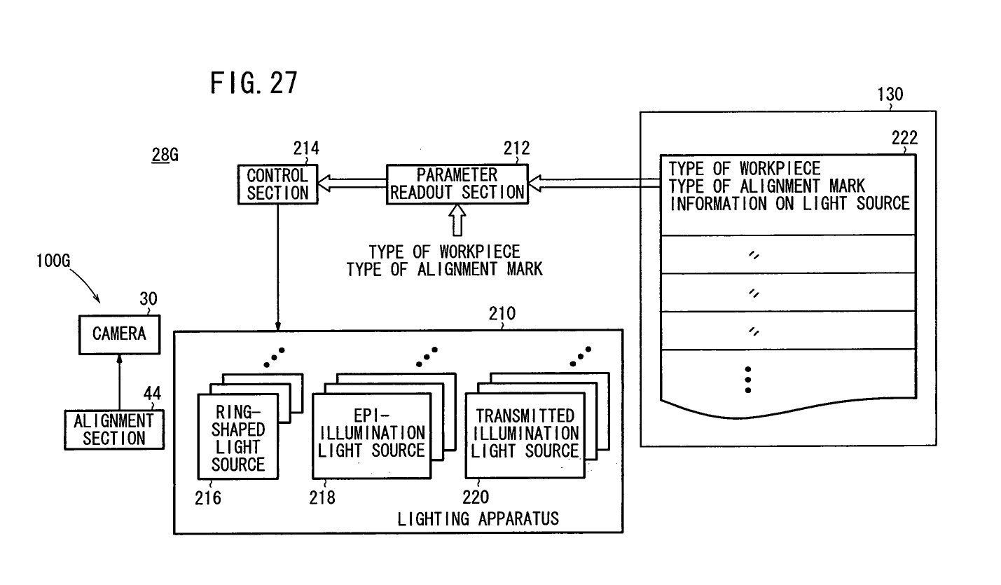

As shown in FIG. 27, in an alignment apparatus 28G according to a seventh embodiment, an alignment light source unit 100G includes a camera 30, a lighting apparatus 210, a memory 130, a parameter readout section 212, and a control section 214.

The lighting apparatus 210 includes a plurality of light sources having different sizes. The different sized light sources include a ring-shaped light source 216, an epi-illumination light source 218, a transmitted illumination light source 220, and the like.

An information-recording table 222 is stored in the memory 130, in which parameters, including at least information on optimum light sources corresponding to the type of workpiece 38 and the type of alignment mark 50 are recorded.

The parameter, corresponding to the type of workpiece 38 and the type of alignment mark 50 being used, is retrieved from the information-recording table 222 by the parameter readout section 212.

The light source corresponding to the light source information of the read-out parameter is selected from among the plural light sources and driven by the control section 214 during an alignment process using an alignment section 44.

Thus, in this embodiment as well, a high-contrast image can be obtained, regardless of the type of workpiece 38 and the type of alignment mark 50, and various subsequent processes, including an exposure treatment, can be carried out with excellent accuracy.

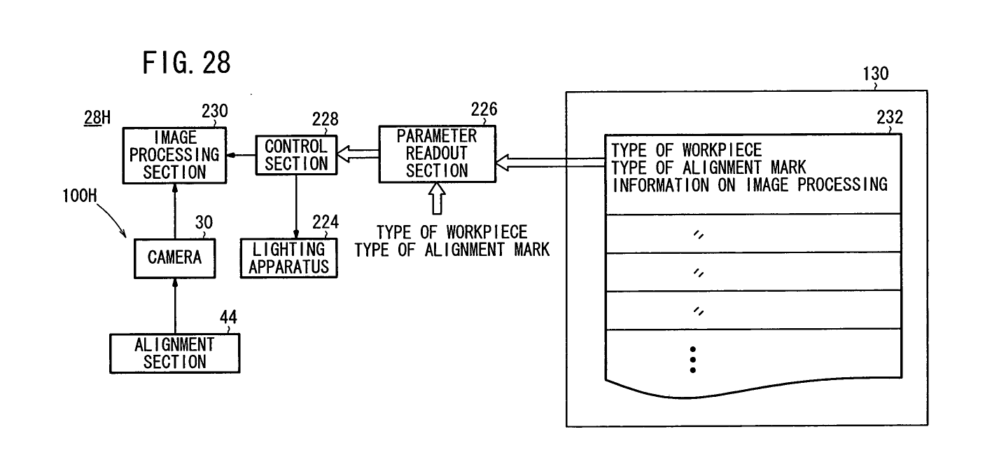

As shown in FIG. 28, in an alignment apparatus 28H according to an eighth embodiment, an alignment light source unit 100H includes a camera 30, a lighting apparatus 224, a memory 130, a parameter readout section 226, a control section 228, and an image processing section 230.

An information-recording table 232 is stored in the memory 130, in which parameters are recorded, including at least information on optimum image processing conditions corresponding to the type of workpiece 38 and the type of alignment mark 50.

The parameter, including information on image processing conditions corresponding to the type of workpiece 38 and the type of alignment mark 50 being used, is retrieved from the information-recording table 232 by the parameter readout section 226.

The parameter that is read-out from the information-recording table 232 is transmitted through the control section 228 to the image processing section 230. An image taken by the camera 30 is subjected to image processing, corresponding to the information on the image processing conditions of the read-out parameter, by the image processing section 228 during an alignment process using an alignment section 44.

Image processing may be carried out by means of the method for obtaining the tone difference, as shown in FIG. 6, or by means of the method for obtaining the tone ratio from the histogram, as shown in FIG. 9, or the like.

Thus, in the present embodiment as well, a high-contrast image can be obtained, regardless of the type of workpiece 38 and the alignment mark 50, and various subsequent processes, including an exposure treatment, can be carried out with excellent accuracy.

Two or more of the above described alignment apparatuses 28E to 28H according to the fifth through eighth embodiments may be used in combination.

The parameters stored in the information-recording tables 196, 208, 222, and 232 may be input by the user via a computer, etc.

In the above description, the alignment apparatuses according to the aforementioned embodiments are used in a digital exposure apparatus 10. Moreover, they can be used in an analog exposure apparatus, an ink jet apparatus, as well as in various other alignment apparatuses.

It should be noted that the light source unit for alignment, the alignment apparatus, the exposure apparatus, the digital exposure apparatus, the alignment method, the exposure method, and the lighting apparatus condition setting method of the present invention are not limited to the above embodiments. Various changes and modifications may be made to these embodiments without departing from the scope of the present invention.

1. A light source unit for alignment, which is used for an alignment means for detecting a standard pattern formed on a workpiece to align the position of said workpiece, comprising a camera for taking an image of said standard pattern and a surrounding area thereof, and a ring-shaped lighting apparatus for emitting light to said standard pattern, comprising:
a changing means for moving said lighting apparatus relatively closer to or farther away from said standard pattern so as to change the distance between said lighting apparatus and said standard pattern;
an image processing means for obtaining quantitative data on contrast between said standard pattern and said surrounding area based on image information from said camera;
an extraction means for selecting an optimum distance between said lighting apparatus and said standard pattern, under which said contrast is optimized, based on said quantitative data from a plurality of distances obtained during relative displacement of said lighting apparatus by said changing means; and
a setting means for setting the distance between said lighting apparatus and said standard pattern to said optimum distance during an alignment process using said alignment means.

2. A light source unit according to claim 1, further comprising:
a memory having a table in which said optimum distance is recorded, corresponding to at least the type of workpiece;
an entry means for recording in said table said optimum distance, corresponding to at least the type of workpiece; and
a readout means for retrieving from said table said optimum distance, corresponding to at least the type of workpiece, of an alignment object during an alignment process using said alignment means,
wherein the distance between said lighting apparatus and said standard pattern is set to said optimum distance by said setting means during an alignment process using said alignment means.

3. A light source unit for alignment, which is used for an alignment means for detecting a standard pattern formed on a workpiece in order to align the position of said workpiece, comprising a camera for taking an image of said standard pattern and a surrounding area thereof, and a ring-shaped lighting apparatus for emitting light to said standard pattern, comprising:
a changing means for changing at least the lighting angle of said light emitted from said lighting apparatus to said standard pattern;
an image processing means for obtaining quantitative data on contrast between said standard pattern and said surrounding area, based on image information from said camera;
an extraction means for selecting an optimum lighting angle, under which said contrast is optimized, based on said quantitative data from a plurality of lighting angles changeable by said changing means; and
a setting means for setting the lighting angle of said lighting apparatus to said optimum lighting angle during an alignment process using said alignment means.

4. A light source unit according to claim 3, wherein:
said lighting apparatus comprises a hollow, dome-shaped casing, and
when a line of light sources on an inner circumference around the center axis of said casing is defined as a row, light sources of 1st, 2nd, . . . , and nth rows are formed on an inner wall of said casing, in this order, from the bottom of said casing.

5. A light source unit according to claim 4, wherein:
a row of said light sources is selected by said changing means from among said 1st, 2nd, . . . , and nth rows in order to change the lighting angle of said lighting apparatus and/or the distance between the driven light sources and said workpiece;
an optimum lighting angle and/or an optimum distance, under which said contrast is optimized, are selected by said extraction means from among a plurality of lighting angles and/or a plurality of distances changeable by said changing means; and
the lighting angle and/or the distance of said lighting apparatus are set by said setting means to said optimum lighting angle and/or said optimum distance during an alignment process using said alignment means.

6. A light source unit according to claim 3, further comprising:
a memory having a table in which said optimum lighting angle and/or said optimum distance, corresponding to at least the type of workpiece, is recorded;
an entry means for recording in said table said optimum lighting angle and/or said optimum distance, corresponding to at least the type of workpiece; and
a readout means for retrieving from said table said optimum lighting angle and/or said optimum distance, corresponding to at least the type of workpiece, of an alignment object during an alignment process using said alignment means,
wherein the lighting angle and/or the distance of said lighting apparatus are set by said setting means to said optimum lighting angle and/or said optimum distance.

7. A light source unit according to claim 5, wherein:
said light sources of each row within said lighting apparatus have different lighting colors,
a row of said light sources is selected from among said 1st, 2nd, . . . , and nth rows in order to change the lighting angle and/or the distance, and part or all of said light sources of the selected row are selected and driven by said changing means in order to change the lighting color,
an optimum lighting angle and/or an optimum distance, as well as an optimum lighting color, under which said contrast is optimized, are selected by said extraction means from among a plurality of lighting angles and/or a plurality of distances, as well as a plurality of lighting colors, changeable by said changing means, and
the lighting angle and/or the distance, as well as the lighting color of said lighting apparatus, are set by said setting means to said optimum lighting angle and/or said optimum distance, as well as said optimum lighting color, during an alignment process using said alignment means.

8. A light source unit according to claim 5, wherein:
said light sources of each row within said lighting apparatus have the same lighting color, and each of adjacent rows have different lighting colors,
a row of said light sources is selected by said changing means from among said 1st, 2nd, . . . , and nth rows, in order to change the lighting angle and/or the distance, and the lighting color,
an optimum lighting angle and/or an optimum distance, as well as an optimum lighting color, under which said contrast is optimized, are selected by said extraction means from a plurality of lighting angles and/or a plurality of distances, as well as a plurality of lighting colors, which are changeable by said changing means, and
the lighting angle and/or the distance, as well as the lighting color, of said lighting apparatus are set by said setting means to said optimum lighting angle and/or said optimum distance, as well as said optimum lighting color, during an alignment process using said alignment means.

9. A light source unit according to claim 7, comprising:
a memory having a table in which said optimum lighting angle and/or said optimum distance, as well as said optimum lighting color, corresponding to at least the type of workpiece is recorded;
an entry means for recording in said table said optimum lighting angle and/or said optimum distance, as said optimum lighting color, corresponding to at least the type of workpiece; and
a readout means for retrieving from said table said optimum lighting angle and/or said optimum distance, as well as said optimum lighting color, corresponding to at least the type of workpiece, of an alignment object during an alignment process using said alignment means,
wherein the lighting angle and/or the distance, as well as the lighting color, of said lighting apparatus are set to said optimum lighting angle and/or said optimum distance, as well as said optimum lighting color, by said setting means during an alignment process using said alignment means.

10. A light source unit for alignment, which is used for an alignment means for detecting a standard pattern formed on a workpiece in order to align the position of said workpiece, comprising a camera for taking an image of said standard patterns and a surrounding area thereof, and a ring-shaped lighting apparatus for emitting light to said standard pattern, comprising:
a changing means for changing at least the lighting color of said light emitted from said lighting apparatus toward said standard pattern;
an image processing means for obtaining quantitative data on contrast between said standard pattern and said surrounding area, based on image information from said camera;
an extraction means for selecting an optimum lighting color, under which said contrast is optimized, based on said quantitative data from a plurality of lighting colors that are changeable by said changing means; and
a setting means for setting the lighting color of said lighting apparatus to said optimum lighting color during an alignment process using said alignment means.

11. A light source unit according to claim 10, wherein:
said lighting apparatus comprises a hollow, dome-shaped casing,
when a line of light sources on an inner circumference around the center axis of said casing is defined as a row, light sources of 1st, 2nd, . . . , and nth rows are formed along an inner wall of said casing, in this order, from the bottom of said casing,
said light sources of each row in said lighting apparatus have the same lighting color, and each of adjacent rows have different lighting colors, and
said light sources of all or part of said 1st, 2nd, . . . , and nth rows are selected and driven by said changing means in order to change the lighting color.

12. A light source unit according to claim 10, further comprising:
a memory having a table in which said optimum lighting color corresponding to at least the type of workpiece is recorded,
an entry means for recording in said table said optimum lighting color corresponding to at least the type of workpiece, and
a readout means for retrieving from said table said optimum lighting color corresponding to at least the type of workpiece of an alignment object during an alignment process using said alignment means,
wherein the lighting color of said lighting apparatus is set to said optimum lighting color by said setting means during an alignment process using said alignment means.

13. A light source unit according to claim 1, wherein:
a tone difference between said standard pattern and said surrounding area is obtained as said quantitative data by said image processing means, and
said contrast is optimized when said tone difference is maximized.

14. A light source unit according to claim 1, wherein:
a histogram, showing the change of pixel number depending on tone, is obtained based on said image information by said image processing means, a peak having the maximum tone value and a peak having the minimum tone value are extracted from a plurality of peaks within said histogram, and the ratio of the maximum tone value to the minimum tone value is obtained as said quantitative data, and
said contrast is optimized when said ratio is maximized.
